(19) United States
(12) Patent Application Publication
(10) Pub. No.: US 2012/0183088 A1
(43) Pub. Date: Jul. 19, 2012

(54) LATTICE REDUCTION ARCHITECTURE AND METHOD AND DETECTION SYSTEM THEREOF

(75) Inventors: Chun-Fu Liao, Kaohsiung City (TW); Fang-Chun Lan, Yilan County (TW); Po-Lin Chiu, Tainan City (TW); Yuan-Hao Huang, Hsinchu County (TW)

(73) Assignee: INDUSTRIAL TECHNOLOGY RESEARCH INSTITUTE, Hsinchu (TW)

(21) Appl. No.: 13/006,446

(22) Filed: Jan. 14, 2011

(51) Int. Cl. H04B 7/02

(52) U.S. Cl. 375/267

(57) ABSTRACT

A lattice reduction architecture, a lattice reduction method and a detection system thereof are proposed. The proposed architecture performs lattice reduction on channel matrices corresponding to sub-carriers and includes G processing group blocks, which receives channel matrices corresponding to the sub-carriers, and each of the first to the G-1th processing group blocks includes k processing modules respectively processing k sub-carriers, and the Gth processing group block includes j processing modules, where j<=k. In each one of the processing group blocks, at least one processing module receives an initial matrix, where the processing module includes a lattice reduction processing unit provides a reduction matrix to at least one neighboring processing module when a lattice reduction algorithm is processed on a channel matrix corresponding to its respective sub-carrier for at least iteration loops according to the channel matrix and the received initial matrix.

### TECHNICAL FIELD

The disclosure generally relates to lattice reduction architecture, lattice reduction method and a detection system thereof.

### BACKGROUND

Recent studies have found lattice-reduction (LR) preprocessing technique suitable for multiple-input multiple-output (MIMO) detection. However, if the LR technique is applied to the orthogonal-frequency-division-multiplexing (OFDM) system, its processing complexity and latency induced by the LR processing could be increased greatly because of the large number of sub-carriers.

In recent years, multiple-input multiple-output (MIMO) OFDM technique has been developed to achieve high-throughput requirement for wideband wireless communication systems, such as third generation project partnership long term evolution (3GPP-LTE) system and a Worldwide Interoperability for Microwave Access (WiMAX) system based on the IEEE 802.16 standard. The OFDM technique can effectively deal with multi-path effect by simple one-tap equalization for each one of the sub-carriers. On the other hand, the MIMO technique can increase transmission rate using multiple transmitting antennas and receiving antennas. Since the MIMO-OFDM baseband receiver usually is required to perform MIMO detection for a large number of sub-carriers, MIMO detection and MIMO matrix preprocessing techniques become important issues in the MIMO-OFDM system.

The lattice reduction (LR) technique is a preprocessing technique that transforms a MIMO matrix into a more orthogonal one by finding a better basis for the same lattice so as to improve the diversity gain of the MIMO detection, where the MIMO matrix refers to the MIMO channel transformation matrix, which provides a one-to-one correspondence between each one of transmitting antennas at a transmitter end and each one of receiving antennas at a receiver end.

FIG. 1 illustrates a MIMO-OFDM system architecture. Referring to FIG. 1, OFDM modulators such as OFDM modulators 111, 112, . . . , 11nₜ, at the transmitter end (on the left hand side of FIG. 1) transforms N symbols into N time-domain signals using Inverse Fast Fourier Transform (IFFT) processing, and then cyclic-prefix (CP) is inserted to combat inter-symbol-interference (ISI), where nₜ is a number of transmitter antennas such as transmitter antenna 121, 122, . . . , 12nₜ. A MIMO encoder 10 converts user data to N symbols and provide the N symbols to the OFDM modulators 111, 112, 11nₜ.

At the receiver end (on the right hand side of FIG. 1), the CP is removed to resist the delay spread caused by multi- path effect. Then, OFDM demodulators such as OFDM demodulators 141, 142, 14nᵣ, at the receiver end performs the FFT operations on the received OFDM symbols to obtain parallel narrow-band sub-carrier symbols, where nᵣ is a number of receiver antennas such as receiver antenna 131, 132, . . . , 13nᵣ. Therefore, frequency selective channel response can be effectively tackled by simple one-tap equalizer. The MIMO decoder 15 converts the sub-carrier symbols back to the user data.

A spatial multiplexing MIMO transmission is considered for the MIMO-OFDM system illustrated in FIG. 1. Also OFDM signals are multiplexed vertically to each one of the antennas at the transmitter end. Since the multi-path effect is removed by the OFDM technique at the MIMO-OFDM receiver end, the signal model for each one of narrow-band sub-carriers in nₜ×nᵣ MIMO system can be modeled by following equation (1).

y=Hx+n Equation (1)

In the equation (1), y is received OFDM signals, x is transmitted OFDM signals, H is channel transformation matrix (referred to channel matrix H thereafter), nₜ and nᵣ are the numbers of transmitting antennas and receiving antennas, respectively; X ∈ Aⁿ^{ᵣ} is the transmitted signal vector; y ∈ Cⁿ^{ᵣ} is the received signal vector; H [h₁, h₂, . . . , hₙ] represents a flat-fading channel matrix; and n ∈ Cⁿ^{ᵣ} is white Gaussian noise with variance σₙ². Moreover, in the equation (1), the set A consists of constellation points of quadrature amplitude modulation (QAM) modulation at the transmitter end, where

$$A = \{ \pm \frac{1}{2} a , … , \pm \frac{\sqrt{M} - 1}{2} a \}$$

denotes real constellation points for the M-QAM (or M-ary QAM) modulation, and the parameter a is used for power normalization here. Then, at the receiver end, there are totally N of MIMO detections required for N sub-carriers. The QR decomposition technique is often applied in the preprocessing of the MIMO detection because the QR decomposition provides decoding efficiency. As such, the channel matrix H may be expressed by equation (2).

H=QR Equation (2)

In the equation (2), Q ∈ Rⁿ^{ᵣ}^{×n}^{ₜ} is an orthogonal matrix, and R ∈ Rⁿ^{ₜ}^{×n}^{ₜ} is an upper triangular matrix. By multiplying matrices Q^{H} on both sides of the equation (1), an equation (3) can be obtained.

ŷQ^{H}y=Rx+Q^{H}n Equation (3)

where Q^{H}n is the white Gaussian noise that experiences a rotation corresponding to an orthonormal matrix. This transformation is required in many MIMO detection algorithms, e.g., QR-based successive interference cancellation (QR-SIC) and K-best algorithms.

In order to perform LR technique on MIMO-OFDM detection, a lattice L is defined as {t₁hᵣ₁+t₂hᵣ₂+ . . . +tₙ_{ₜ}hᵣₙ_{ₜ}|t₁ . . . tₙ_{ᵣ} ∈ Z}, where {hᵣ₁, . . . , hᵣₙ_{ₜ} ∈ Rⁿ} are the basis vectors. The LR algorithm aims to find a unimodular matrix T (|detT|=1, and all elements of the unimodular matrix T are integers) such that a more orthogonal matrix Ĥᵣ=HᵣT has the same lattice as Hᵣ. Thus, the signal model of the MIMO-OFDM system illustrated in FIG. 1 becomes equation (4).

ŷᵣ+Hᵣxᵣ+nᵣ=ĤᵣT⁻¹xᵣ+nᵣ=Ĥᵣs+nᵣ Equation (4)

In the equation (4), since {xᵣ ∈ Zⁿ}, {T⁻¹xᵣ=s ∈ Zⁿ}. In real cases, the transmitted OFDM signals do not belong to an integer set; however, the signals {xᵣ ∈ Aⁿ} can be still transformed into an integer set by linear operations such as scaling and shifting. A well-known Lenstra-Lenstra-Lovasz (LLL) algorithm is used for lattice reduction due to its polynomial execution time.

The equation (1) can be further expressed in following equation (5).

$$\begin{matrix}y = Hx + n \\ = QRx + n \\ = [ \begin{matrix}{Q}_{11} & {Q}_{12} & … & {Q}_{1 N} \\ {Q}_{21} & {Q}_{22} & … & {Q}_{2 N} \\ ⋮ & ⋮ & ⋱ & ⋮ \\ {Q}_{M 1} & … & {Q}_{MN - 1} & {Q}_{MN}\end{matrix} ] \\ [ \begin{matrix}{R}_{11} & {R}_{12} & … & {R}_{1 N} \\ 0 & {R}_{22} & … & {R}_{2 N} \\ ⋮ & ⋱ & ⋱ & ⋮ \\ 0 & … & 0 & {R}_{NN}\end{matrix} ] [ \begin{matrix}{x}_{1} \\ {x}_{2} \\ ⋮ \\ {x}_{N}\end{matrix} ] + n\end{matrix} \qquad Equation ( 5 )$$

In the equation (5), the received signals vector y can be expressed in terms of the matrix multiplication of matrices Q and R and transmitted signals vector x, plus the noise vector n. Also, in the equation (5), matrix Q is an M×N orthonormal matrix, and matrix R is an N×N upper triangular matrix. Inverse of the channel transformation matrix H are quickly obtained through the QR decomposition. Subsequently, the transmitted symbols can be detected at the receiver end according to the calculated inverse matrix H⁻¹ so as to recover the user data.

Referring to FIG. 2, FIG. 2 is a flowchart illustrating LR method by LLL algorithm according an exemplary embodiment of the present disclosure. The LLL algorithm can be broken into two parts of flowchart as shown in FIG. 2: the first part (step S21) is the size reduction operations; and the second part (step S22) is the LLL reduction operations; the step S23 is to swap the k-1th column with kth column in matrices R and T. Since LLL algorithm is a conventional approach for the lattice reduction, the details of the LLL algorithm and the steps (1) and (2) will not be described here. The number of iterations performed in the size reduction (step S21) depends on the index k, and the LLL reduction operation (step S22) may increase or decrease the index k. Thus, both of the reduction operations (the step S21 and the step S22) result in variable throughput. The critical computational path of these operations (the step S21 and the step S22) determines the latency of algorithm. For example, the size reduction operations may include one division, one multiplication, and one addition due to the parallel processing of vector multiplication.

FIG. 3A illustrates a parallel LR-aided MIMO OFDM detection processing architecture. FIG. 3B illustrates a sequential LR-aided MIMO OFDM detection processing architecture. Referring to FIG. 3A, in the parallel LR-aided MIMO OFDM detection processing architecture, each one of the OFDM sub-carriers is processed independently and in parallel with other OFDM sub-carriers. Usually, the parallel LR-aided MIMO OFDM detection processing architecture includes a plurality of parallel processing modules, where each one of the parallel process modules includes a LR processing unit 311, and a decision unit 315. The processing sequence is shown as a dashed line 3P in FIG. 3A, where the channel matrix H⁽¹⁾ corresponding to the first received sub-carrier y⁽¹⁾ is firstly input to the LR unit 311, and then processed in the LR unit 311 iteratively in loops until the effects of other antennas off the diagonal elements of the channel matrix H⁽¹⁾ are minimal with respect to the antennas on the diagonal elements. Next, the LR processing unit 311 outputs two parameters such as the multiplication result H⁽¹⁾T⁽¹⁾ (shown in dashed block 313) and just the reduction matrix T⁽¹⁾ (shown in dashed block 314). Both H⁽¹⁾T⁽¹⁾ and T⁽¹⁾ are further input to the decision unit 315 along with the first received sub-carrier y⁽¹⁾, the decision unit 315 outputs x⁽¹⁾ as the demodulated sub-carrier x⁽¹⁾.

Each one of the received OFDM sub-carriers in the parallel LR-aided MIMO OFDM detection processing architecture is processed in a similar manner as the first received sub-carrier y⁽¹⁾. So, the Nth received sub-carrier y^{(N)} is input to the decision unit 3N5, and the decision unit 3N5 outputs the x^{(N)} as the demodulated sub-carrier x^{(N)} after the LR unit 3N1 processes the channel matrix H^{(N)} corresponding to the Nth received sub-carrier y^{(N)}, where N is positive integer.

Although the parallel architecture shown in FIG. 3A may achieve a very high throughput, the complexity of N of LR preprocessing is very high. Therefore, it is observed that the MIMO channels in the neighboring sub-carriers are usually coherent and proposed to use the neighboring reduction matrix T to reduce the iteration loops of LLL reduction, as shown in FIG. 3B.

Referring to FIG. 3B, in the sequential LR-aided MIMO OFDM detection processing architecture, each one of the received OFDM sub-carriers is processed one by one in a sequential manner such as indicated by the dashed line 3S. In the example shown in FIG. 3B, the first processing module for the first received sub-carrier y⁽¹⁾ includes a multiplier 316, an LR processing unit 311 and a decision unit 315. Other processing modules for the other received sub-carriers are similar to that of the first received sub-carrier y⁽¹⁾.

According to the dashed line 3S, in the sequential LR-aided MIMO OFDM detection processing architecture, an initial matrix Tᵢₙᵢₜ₁ is multiplied (vector multiplication) by the channel matrix H⁽¹⁾ corresponding to the first received sub-carrier y⁽¹⁾ at the multiplier 316, and the multiplication result H⁽¹⁾Tᵢₙᵢₜ₁ is input to the LR processing unit 311. After iterations of processing, the LR processing unit 311 outputs multiplication result H⁽¹⁾T⁽¹⁾ and just the reduction matrix T⁽¹⁾. The decision unit 315 receives inputs of the first received sub-carrier y⁽¹⁾, multiplication result H⁽¹⁾T⁽¹⁾ and the reduction matrix T⁽¹⁾, and outputs the x⁽¹⁾ as the demodulated sub-carrier x⁽¹⁾. The reduction matrix T⁽¹⁾ is also supplied to the second processing module for the second received sub-carrier y⁽²⁾, and is input to the multiplier 326 in particular.

The second processing module is similar to the first processing module for the first received sub-carrier y⁽¹⁾, and includes the multiplier 326, an LR processing unit 321 and a decision unit 325. While the decision unit 325 receives inputs of second received sub-carrier y⁽²⁾, the multiplication result H⁽²⁾T⁽²⁾ and an reduction matrix T⁽²⁾ for generating the x⁽²⁾ as the demodulated sub-carrier x⁽²⁾, the reduction matrix T⁽²⁾ is further supplied to the third processing module. The same pattern is repeated until the N-1th reduction matrix T^{(N-1)} is generated by the N-1 th processing module and supplied to a multiplier 3N6 of the Nth processing module, which is used to process the Nth received sub-carrier y^{(N)}. Similarly, demodulated sub-carrier x^{(N)} is generated by the decision unit 3N5, which receives multiplication result H^{(N)}T^{(N)} and the reduction matrix T^{(N)} output from LR processing unit 3N1.

The sequential lattice reduction architecture shown in FIG. 3B requires lower computational complexity than the parallel architecture shown in FIG. 3A because the adjacent sub-carrier channels have similar lattice matrix. However, the sequential processing architecture leads to a very long processing latency for the lattice reduction operation. Moreover, the sequential processing shown in FIG. 3B may require a matrix multiplication and at least {nₜ=1} of LLL processing loops to finish the LLL lattice-reduction algorithm for each one of the OFDM sub-carriers except the first sub-carrier. If the channel correlation is not high enough and T matrix of the neighboring sub-carrier is used as preprocessing, this may also increase the processing complexity.

FIG. 3C illustrates another LR-aided MIMO OFDM detection processing architecture. Referring to FIG. 3C, N sub-carriers are divided into N/k groups, and the matrix T with this group is used as the initial T matrix for next group. Each one of the sub-carrier group blocks is input the received sub-carriers along with corresponding channel matrices, and then generate the demodulated sub-carriers. For example, the sub-carrier group block #1 is input the received sub-carriers y⁽⁰⁾, . . . , y^{(k-)}, and corresponding channel matrices H⁽⁰⁾, . . . , H^{(k-1)}, and then generate the corresponding demodulated sub-carriers x⁽⁰⁾, . . . x^{(k-1)}.

Also, in every group illustrated in FIG. 3C, just only one lattice reduction processing is performed. The processing sequence is shown as a dashed line 3PS in FIG. 3C, where the sub-carrier group block #1 provides an initial matrix T⁽⁰⁾ to the sub-carrier group block #2, the sub-carrier group block #2 provides an initial matrix T⁽¹⁾ to the sub-carrier group block #3, and the same pattern repeats until the last one of the initial matrix T^{((N/k)-2)} is provided to the sub-carrier group block #(N/k).

For the MIMO-OFDM system, the LR preprocessing complexity becomes very high because the LR preprocessing must be performed for all sub-carriers. However, the LR preprocessing could only be performed once for all MIMO matrices within the coherent time and coherent bandwidth. Although the sequential lattice reduction architecture shown in FIG. 3B may reduce the computational complexity, the sequential lattice reduction architecture greatly increases the computational latency. That makes it difficult to have the sequential lattice reduction architecture implemented for high-throughput wireless communication system. Therefore, it is a major concern to modify conventional LR processing architecture so as to reduce the computational complexity and shorten the processing latency for the lattice reduction.

### SUMMARY

An exemplary embodiment of a lattice reduction architecture is introduced herein. According to an exemplary embodiment, the lattice reduction architecture is adapted for performing lattice reduction on channel matrices respectively corresponding to a plurality of sub-carriers. The lattice reduction architecture includes G processing group blocks, which are configured for receiving the sub-carriers and the channel matrices, where each one of the first processing group block to the G-1th processing group block includes k processing modules configured for respectively processing k of sub-carriers, and the Gth processing group block includes j processing modules, where G, j, and k are positive integers, and j<=k. Moreover, in each one of the G processing group blocks, at least one of the processing modules receives an initial matrix Tᵢₙᵢₜ, where each one of the at least one processing module includes a lattice reduction processing unit configured for providing a reduction matrix Tₜₑₘₚ to at least one neighboring processing module in the same processing group block when a lattice reduction algorithm is processed on the channel matrix corresponding to its respective sub-carrier for at least predetermined iteration loops according to the channel matrix corresponding to the sub-carriers and the received initial matrix Tᵢₙᵢₜ.

An exemplary embodiment of a lattice reduction method is introduced herein. According to an exemplary embodiment, the lattice reduction method is adapted for performing lattice reduction on channel matrices respectively corresponding to a plurality of received sub-carriers. The lattice reduction method includes following steps. N received sub-carriers are grouped to ┌N/k┐ groups, where N and k are positive integers, and ┌┐ is a ceiling function. Channel matrices are received respectively corresponding to each one of the received sub-carriers. For each one of the ┌N/k┐ groups, an initial matrix Tᵢₙᵢₜ is received at least one of the processing modules in the each one of the ┌N/k┐ groups. The channel matrix corresponding to its respective sub-carrier is processed at the at least one of the processing modules in the each one of the ┌N/k┐ groups by a lattice reduction algorithm for at least predetermined iteration loops according to the channel matrix corresponding to the respective sub-carrier and the received initial matrix Tᵢₙᵢₜ. In addition, a reduction matrix Tₜₑₘₚ is provided to at least one neighboring processing module in the same group when the channel matrix corresponding to the respective sub-carrier is processed at the at least one of the processing modules by the lattice reduction algorithm for at least predetermined iteration loops.

An exemplary embodiment of a detection system is introduced herein. According to an exemplary embodiment, the detection system is adapted for detecting received signals. The detection system includes G processing group blocks and a channel correlation estimator unit. The G processing group blocks are configured for receiving channel matrices corresponding to the received signals, where each one of the first processing group block to the G-1th processing group block includes k processing modules configured for respectively processing k of received signals, and the Gth processing group block includes j processing modules, where G, j, and k are positive integers, and j<=k. Also, in each one of the G processing group blocks, at least one of the processing modules receives an initial matrix Tᵢₙᵢₜ, where each one of the at least one processing module includes a lattice reduction processing unit configured for providing a reduction matrix Tₜₑₘₚ to at least one neighboring processing module in the same processing group block when a lattice reduction algorithm is processed on a channel matrix corresponding to its respective received signals for at least predetermined iteration loops according to the channel matrix corresponding to the received signals and the received initial matrix Tᵢₙᵢₜ. Moreover, the channel correlation estimator unit is connected to all processing modules in each one of the G processing group blocks. In addition, the channel correlation estimator unit is configured for estimating correlations between a plurality channels and adjusting the predetermined iteration loops according to the estimated correlations of the channels.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a MIMO-OFDM system architecture.

FIG. 2 is a flowchart illustrating LR method by LLL algorithm according an exemplary embodiment.

FIG. 3A illustrates a parallel LR-aided MIMO OFDM detection processing architecture.

FIG. 3B illustrates a sequential LR-aided MIMO OFDM detection processing architecture.

FIG. 3C illustrates another sequential LR-aided MIMO OFDM detection processing architecture.

FIG. 4A is a schematic diagram illustrating a lattice reduction architecture according to a first exemplary embodiment.

FIG. 4B is a schematic diagram illustrating a lattice reduction architecture according to a second exemplary embodiment.

FIG. 5 is schematic diagram illustrating a lattice reduction architecture according to a third exemplary embodiment.

FIG. 6A is schematic diagram illustrating a lattice reduction architecture according to a fourth exemplary embodiment.

FIG. 6B is schematic diagram illustrating a lattice reduction architecture according to a fifth exemplary embodiment.

FIG. 7A is schematic diagram illustrating a lattice reduction architecture according to a sixth exemplary embodiment.

FIG. 7B is schematic diagram illustrating a lattice reduction architecture according to a seventh exemplary embodiment.

FIG. 7C is schematic diagram illustrating a lattice reduction architecture according to an eighth exemplary embodiment.

FIG. 7D is schematic diagram illustrating a lattice reduction architecture according to a ninth exemplary embodiment.

FIG. 7E is schematic diagram illustrating a lattice reduction architecture according to a tenth exemplary embodiment.

FIG. 8 is flowchart illustrating a lattice reduction method according to an exemplary embodiment.

FIG. 9 is a diagram illustrating signal-to-noise-ratio (SNR) performance versus bit-error-rate (BER) performance for different LR architectures.

FIG. 10 and FIG. 11 show the computational complexity and latency of different architectures.

FIG. 12 is a functional block diagram illustrating a detection system according an exemplary embodiment.

### DESCRIPTION OF THE EXEMPLARY EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

In the present disclosure, there is proposed a new lattice reduction processing architecture for LR-aided MIMO-OFDM system. The present disclosure is not limited to the OFDM system, and the proposed LR processing architecture could also be applied to other wireless communication system adopting MIMO architecture. The proposed LR processing architecture and method thereof can reduce the number of iteration loops by using a preprocessing matrix of adjacent sub-carrier L. Moreover, the grouping of sub-carriers is adopted in the proposed LR processing architecture and method thereof, such that the long critical computational path could be broken so as to reduce the computational complexity and latency.

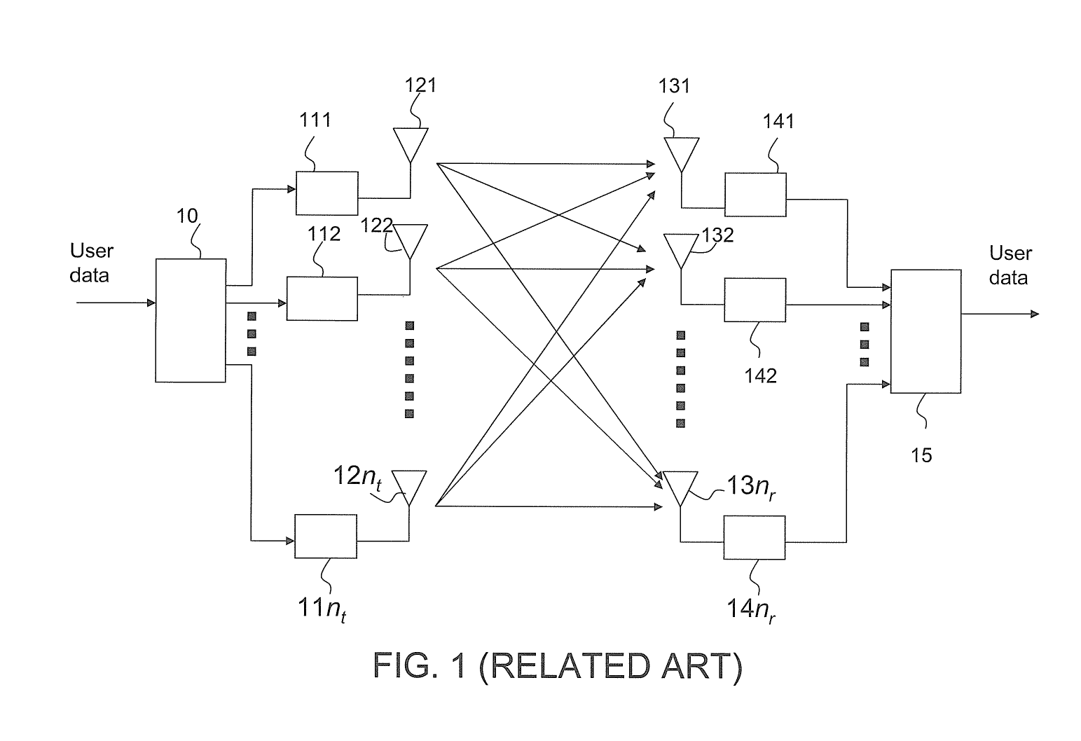

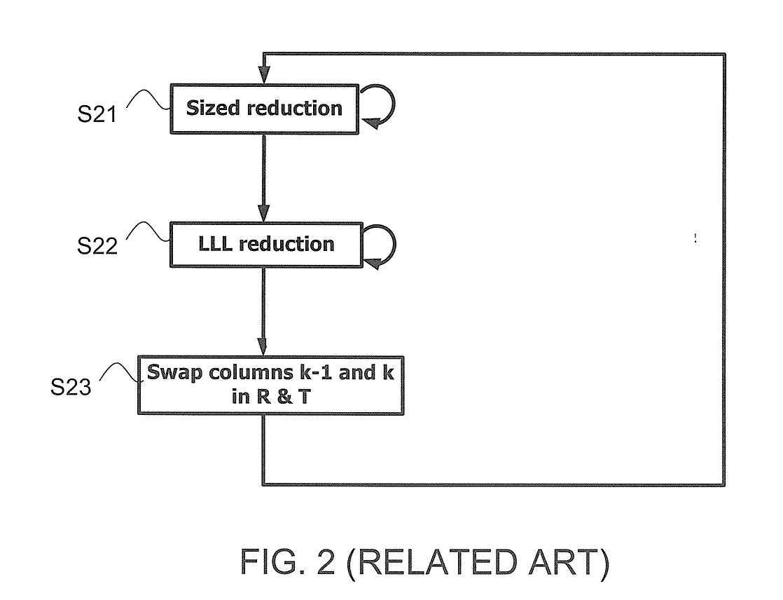

In the present disclosure, only the spatial multiplexing MIMO transmission is considered for the MIMO-OFDM system illustrated in FIG. 1. Also, OFDM signals are multiplexed vertically to each one of the antennas at the transmitter end. The MIMO-OFDM system is taken for an example for illustration but the present disclosure is not limited to the MIMO-OFDM system.

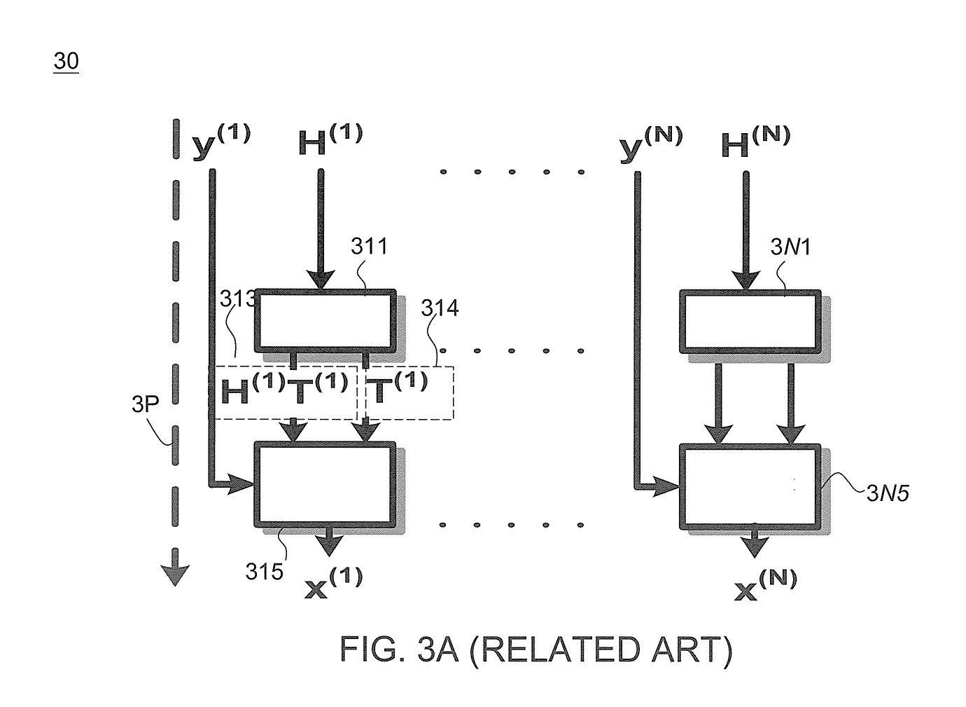

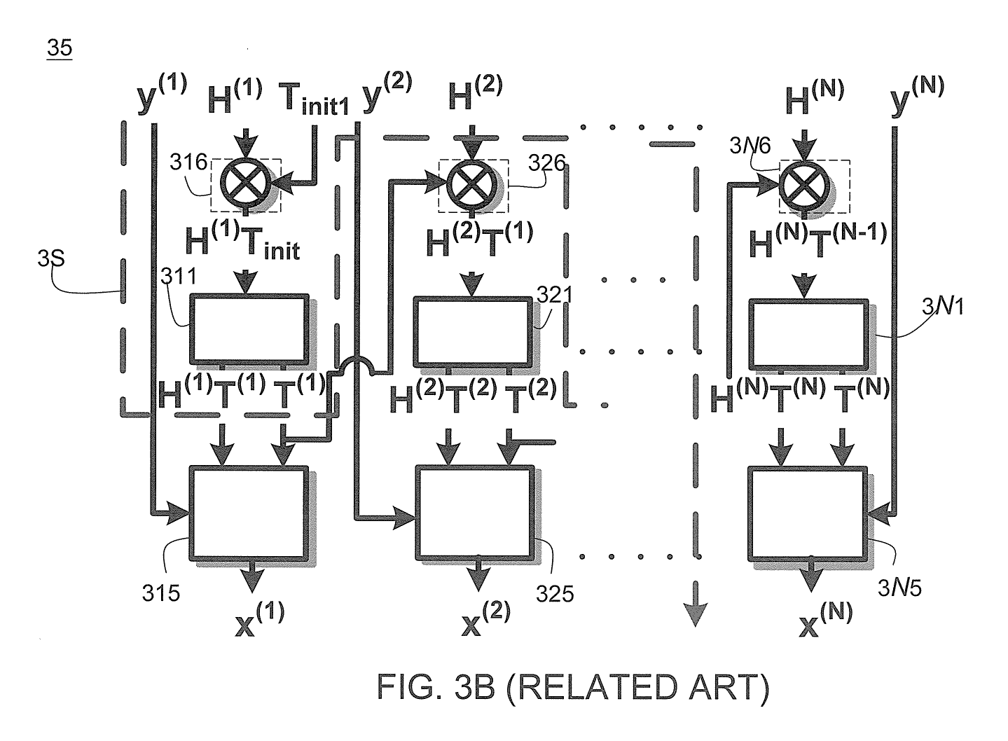

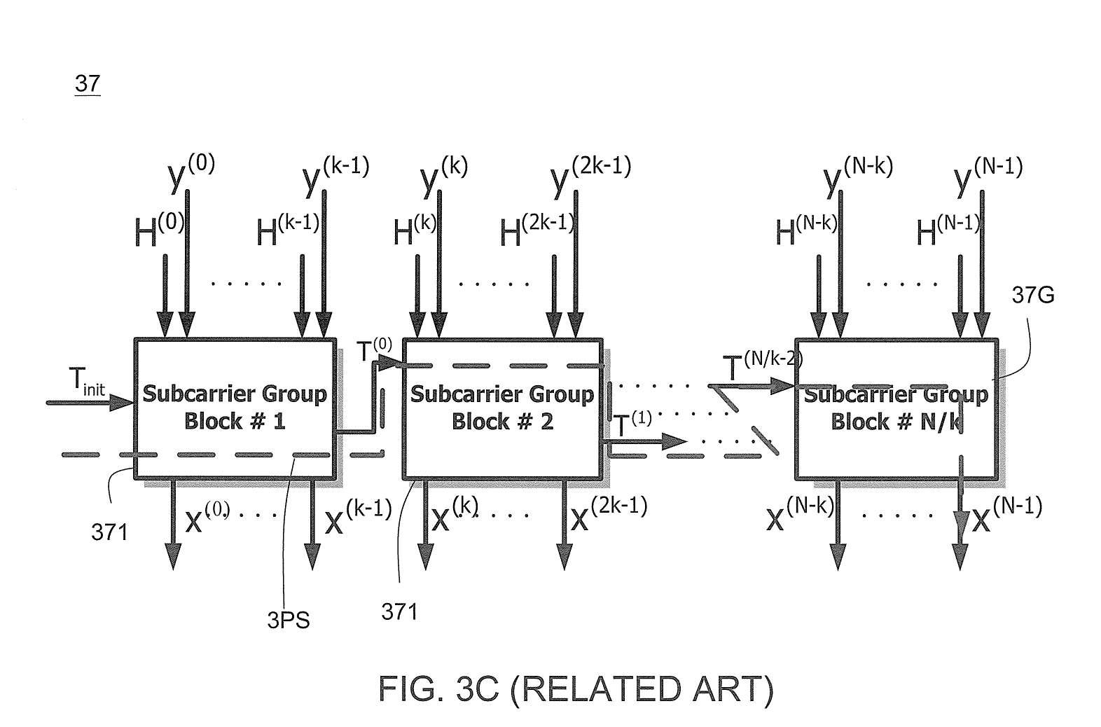

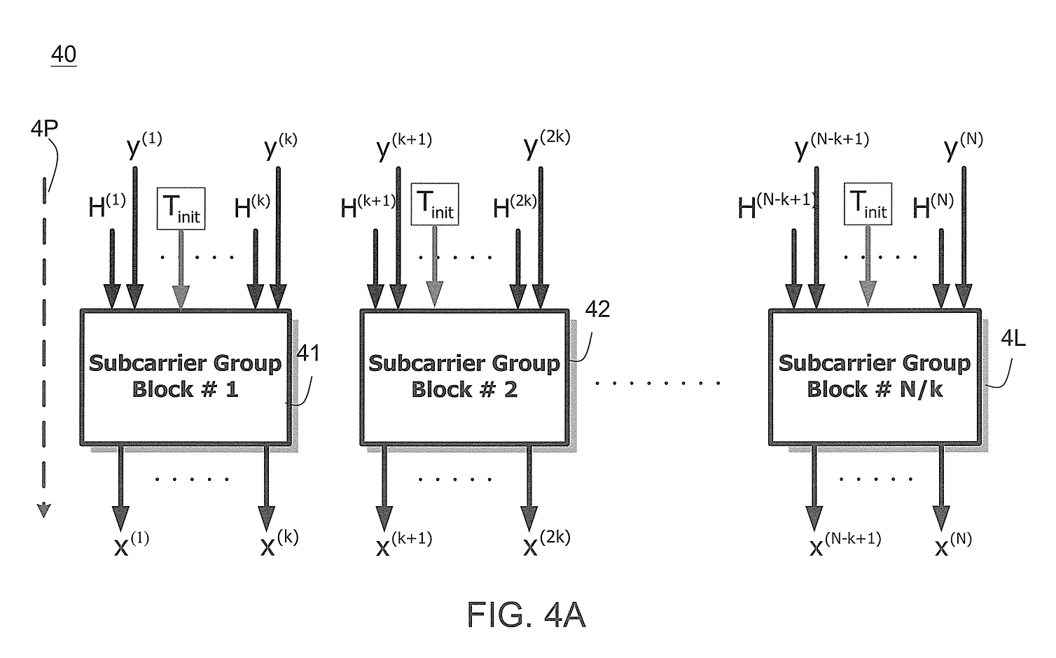

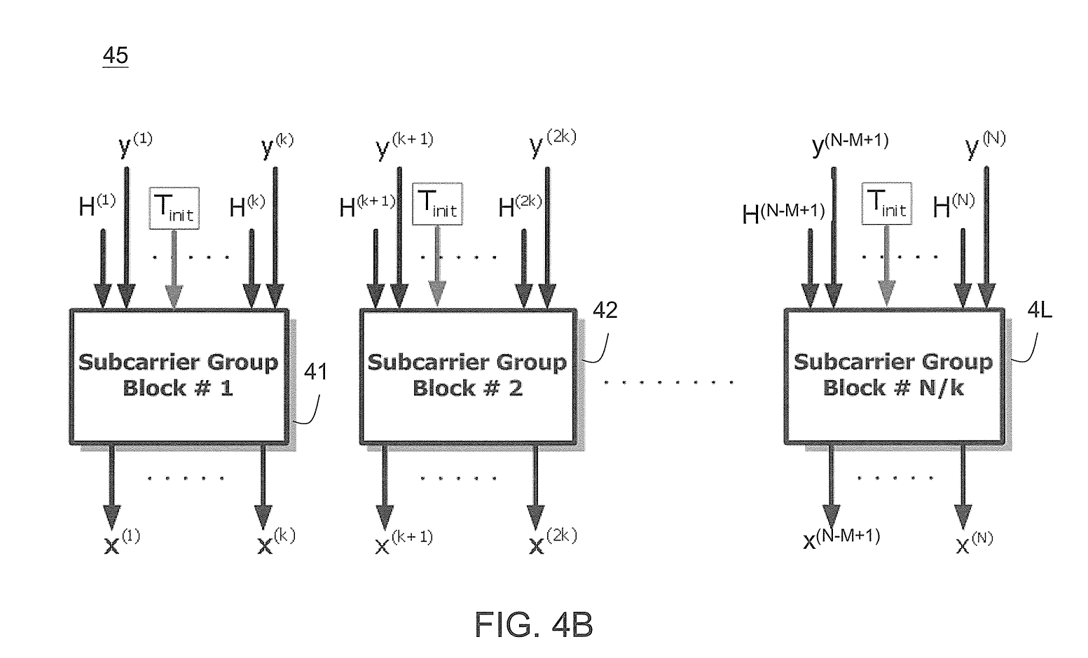

Referring to FIG. 4A, FIG. 4A is a schematic diagram illustrating a lattice reduction architecture 40 according to a first exemplary embodiment. In the LR architecture 40, it is assumed initially there are N of received OFDM sub-carriers required to be processed in the LR architecture 40. In fact, this assumption can be applied to following exemplary embodiments illustrated in FIGS. 4B, 5, 6A-6B and 7A-7E. Referring to FIG. 4A, every k sub-carriers are grouped in a sub-carrier group, where k is a positive number. Also, the grouped sub-carriers are respectively processed by its corresponding processing modules in a manner similar to a hybrid of parallel LR-aided MIMO OFDM detection processing architecture and sequential LR-aided MIMO OFDM detection processing architecture as shown in FIGS. 3A-3B. However, only the sub-carriers in the same sub-carrier group are related but different sub-carriers group blocks are processed independently.

For example, the LR architecture 40 includes blocks 41, 42, . . . , 4L such as sub-carrier group blocks #1, #2, . . . , #(N/k), but each one of the sub-carrier group blocks are operating independently from other sub-carrier group blocks. The operation of each one of the sub-carrier group blocks follows the direction of a dashed line 4P. Moreover, the long processing latency induced by the pure sequential LR-aided MIMO OFDM detection processing architecture is reduced while the LR architecture 40 has less complexity compared to the pure parallel LR-aided MIMO OFDM detection processing architecture.

To make the LR architecture 40 illustrated more clearly, each one of the sub-carrier group blocks #1, #2, . . . , #(N/k) is supplied with an initial matrix Tᵢₙᵢₜ along with respective input sub-carriers. For example, the sub-carrier group block #1 receives inputs of received OFDM sub-carriers y⁽¹⁾, . . . , y^{(k)}, with their respective or corresponding channel matrix H⁽¹⁾, . . . , H^{(k)}. One or more processing modules in the sub-carrier group block #1 is processed firstly with the initial matrix Tᵢₙᵢₜ, and reduction matrix Tₜₑₘₚ can be provided by the firstly operated processing modules to one or more neighboring processing modules in the same sub-carrier group block #1.

Every time when one of the processing modules in the sub-carrier group block #1 receives the reduction matrix Tₜₑₘₚ, it can start its own processing of a channel matrix corresponding to its respective sub-carrier. The processing modules, which process their own channel matrices corresponding to their respective sub-carriers completely or process the channel matrices corresponding to their respective sub-carriers in predetermined iteration loops, can also provide a reduction matrix Tₜₑₘₚ to one or more neighboring processing modules in the same sub-carrier group block #1. This operation approach repeats in the sub-carrier group block #1 until all of the processing modules have been operating, and demodulated/detected sub-carriers x⁽¹⁾, . . . , x^{(k)} are generated. Also, the aforementioned operation is described for processing sub-carriers within fixed time duration, such as a sub-frame in an OFDM symbol.

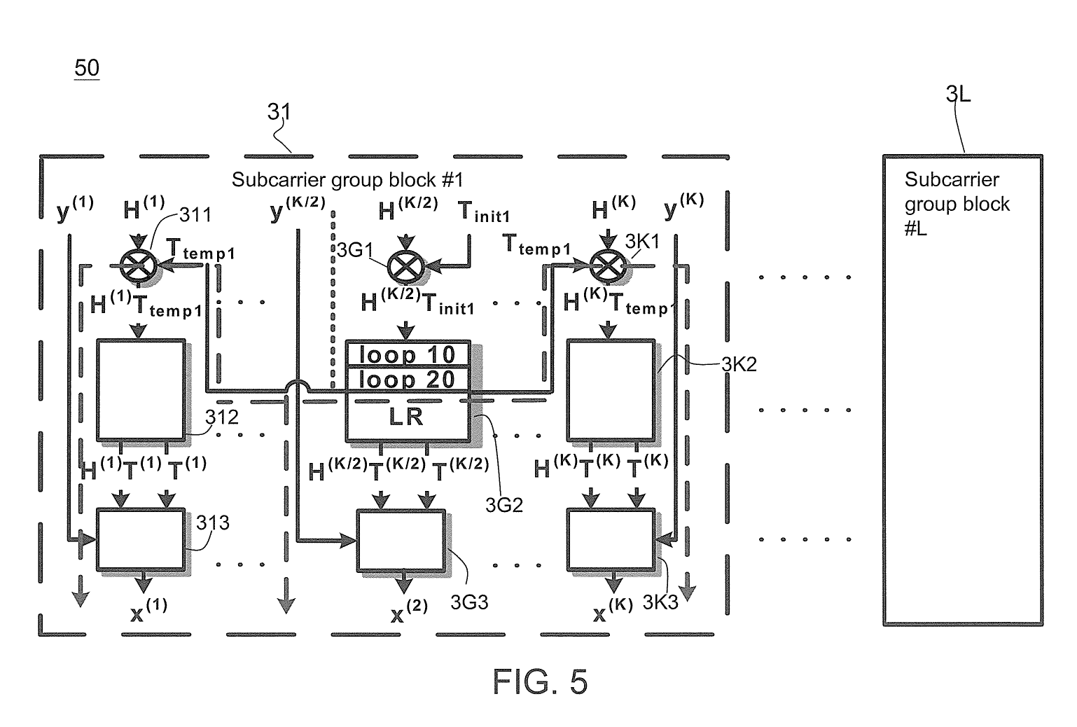

The same operation approach can be applied to the sub-carrier group block #2, . . . , the sub-carrier group block #(N/k). The sub-carrier group block #2 receives inputs of received sub-carriers y^{(k+1)}, y^{(2k)}, with their respective or corresponding channel matrix H^{(k+1)}, . . . , H^{(2k)} along with the initial matrix Tᵢₙᵢₜ, and the demodulated sub-carriers x^{(k+1)}, . . . , x^{(2k)} are generated accordingly. Similarly, the sub-carrier group block #(N/k) receives inputs of received sub-carriers y^{(N-k+1)}, . . . , y^{(N)}, (with their respective or corresponding channel matrix H^{(N-k+1)}, . . . , H^{(N)} along with the initial matrix Tᵢₙᵢₜ, and the demodulated sub-carriers x^{(N-k+1)}, . . . , x^{(N)} are generated accordingly. However, the present disclosure is not limited to the aforementioned scheme. In some embodiments, any one of the sub-carrier group block #1, the sub-carrier group block #2, . . . , the sub-carrier group block #(N/k) can be applied with different operation methods. The details of different operation approaches can be referred to FIGS. 5, 6A-6B and 7A-7E.

FIG. 4B is a schematic diagram illustrating a lattice reduction architecture 45 according to a second exemplary embodiment. Referring to FIG. 4B, the LR architecture 45 is similar to the LR architecture 40. However, in the LR architecture 40, the total number of sub-carriers, N, is divisible by the group size k. In other words, in the LR architecture 40, the computation of N modulo k produces a result of zero. On the other hand, the total number of sub-carriers, N, is not divisible by the group size k in the LR architecture 45. Thus, the number of sub-carriers in the sub-carrier group block #(N/k) (i.e., the block 3L) in the LR architecture 45 is the computation result of N modulo k. As such, in the LR architecture 45, the sub-carrier group block #(N/k) receives inputs of received OFDM sub-carriers y^{(N-M+1)}, . . . , y^{(N)}, with their respective or corresponding channel matrix H^{(N-M+1)}, . . . , H^{(N)} along with the initial matrix Tᵢₙᵢₜ, and the demodulated sub-carriers x^{(N-M+1)}, . . . , x^{(N)} are generated accordingly.

FIG. 5 is schematic diagram illustrating a lattice reduction architecture 50 according to a third exemplary embodiment. The lattice reduction architecture 50 is similar to the lattice reduction architecture 35, and includes blocks 31, . . . , 3L. Also, the block 31 (i.e., the sub-carrier group block #1) illustrates one of the different operation approaches which can be applied to any sub-carrier group blocks in the lattice reduction architecture 35.

Referring to FIG. 5, the number of the processing modules in the sub-carrier group block #1 may be odd number or even number. The processing modules in the middle (or in the middle column) of the sub-carrier group block #1 includes a multiplier 3G1, a LR processing unit 3G2, and a decision unit 3G3. The multiplier 3G1 receives inputs of received OFDM sub-carriers H^{(k/2)} with an initial matrix Tᵢₙᵢₜ, and outputs multiplication result H^{(k/2)}Tᵢₙᵢₜ. The multiplication result H^{(k/2)}Tᵢₙᵢₜ is further input to the LR processing unit 3G2. The LR processing unit 3G2 provides a reduction matrix Tₜₑₘₚ₁ before the LR processing is complete. The reduction matrix Tₜₑₘₚ₁ can be provided to one or more neighboring processing modules within fixed time duration such as 10 loops or 20 loops.

The LR processing unit 3G2 normally provides the reduction matrix Tₜₑₘₚ₁ to the processing modules adjacent to it, such that the reduction matrix Tₜₑₘₚ is successively generated in the adjacent processing modules and further provided to other adjacent processing modules until all processing modules have been operating. In other words, the reduction matrix Tₜₑₘₚ is successively generated in processing modules until the first processing modules (the one including a multiplier 311, a LR processing unit 312, and a decision unit 313) and the last processing modules (the one including a multiplier 3K1, a LR processing unit 3K2, and a decision unit 3K3) receive the reduction matrix Tₜₑₘₚ. Meanwhile, the LR processing unit 3G2 continue to complete the LR processing, so as to output the multiplication result H^{(k/2)}T^{(k/2)} and reduction matrix T^{(k/2)}. The decision unit 3G3 receives the input of the received OFDM sub-carrier y^{(k/2)} along with the multiplication result H^{(k/2)}T^{(k/2)} and the reduction matrix T^{(k/2)} and output the demodulated sub-carriers x^{(k/2)} accordingly.

From another perspectives, the lattice reduction architecture 50 is adapted for performing lattice reduction on channel matrices corresponding to a plurality of received sub-carriers y⁽¹⁾, . . . , y^{(N)}, and includes G processing group blocks, and at least a memory unit (or a database module). The G processing group blocks are configured for receiving channel matrices H⁽¹⁾, . . . , H^{(N)} respectively corresponding to each one of the sub-carriers y⁽¹⁾, . . . , y^{(N)}. Each one of the first processing group blocks to the G-1th processing group block includes k processing modules configured for respectively processing channel matrices corresponding to k of sub-carriers, and the Gth processing group block includes j processing modules, where G, j, and k are positive integers, and j>=k. In fact, j is a computation result of N modulo k.

In each one of the G processing group blocks, one or more of the processing modules receives an initial matrix Tᵢₙᵢₜ, where each one of the processing module includes a lattice reduction processing unit configured for providing a reduction matrix Tₜₑₘₚ to one or more of the neighboring processing modules in the same processing group block. The one or more of the processing modules receiving the initial matrix Tᵢₙᵢₜ can provide reduction matrix Tₜₑₘₚ to one or more of the neighboring processing modules in the same processing group block when a lattice reduction algorithm is processed on the channel matrix corresponding to its respective sub-carrier for at least predetermined iteration loops according to the channel matrix corresponding to the sub-carrier and the received initial matrix Tᵢₙᵢₜ. The initial matrix Tᵢₙᵢₜ may be, for example, an identity matrix when the lattice reduction algorithm is performed for the very first time.

In the lattice reduction algorithm can be, for example, a Lenstra-Lenstra-Lovasz (LLL) algorithm. However, the present disclosure is not limited thereto. The lattice reduction algorithm could also be Seysen's algorithm or other lattice reduction algorithms.

The one or more of the processing modules receiving the reduction matrix Tₜₑₘₚ can further provide another reduction matrix Tₜₑₘₚ₁ to one or more of neighboring processing modules which have not received any reduction matrix or the initial matrix in the same processing group block. The processing modules receiving the reduction matrix Tₜₑₘₚ can provide another reduction matrix Tₜₑₘₚ₁ to one or more of the neighboring processing modules when lattice reduction algorithm is processed for the at least predetermined iteration loops according to the channel matrix corresponding to the sub-carriers and the received reduction matrix Tₜₑₘₚ. The predetermined iteration loops can be, for example, 10 loops or 20 loops as shown in FIG. 5.

However, in other embodiment of the present disclosure, the lattice reduction processing unit receiving the initial matrix Tᵢₙᵢₜ can also provide the reduction matrix Tₜₑₘₚ when the lattice reduction algorithm is processed completely on the channel matrix corresponding to its respective sub-carrier according to the channel matrix corresponding to the sub-carrier and the received initial matrix Tᵢₙᵢₜ.

The at least one processing module receiving the reduction matrix Tₜₑₘₚ further provides another reduction matrix Tₜₑₘₚ₁ to at least one neighboring processing modules which have not received any reduction matrix or the initial matrix in the same processing group block when its respective lattice reduction algorithm is processed completely according to the channel matrix corresponding to the sub-carrier and the received reduction matrix Tₜₑₘₚ.

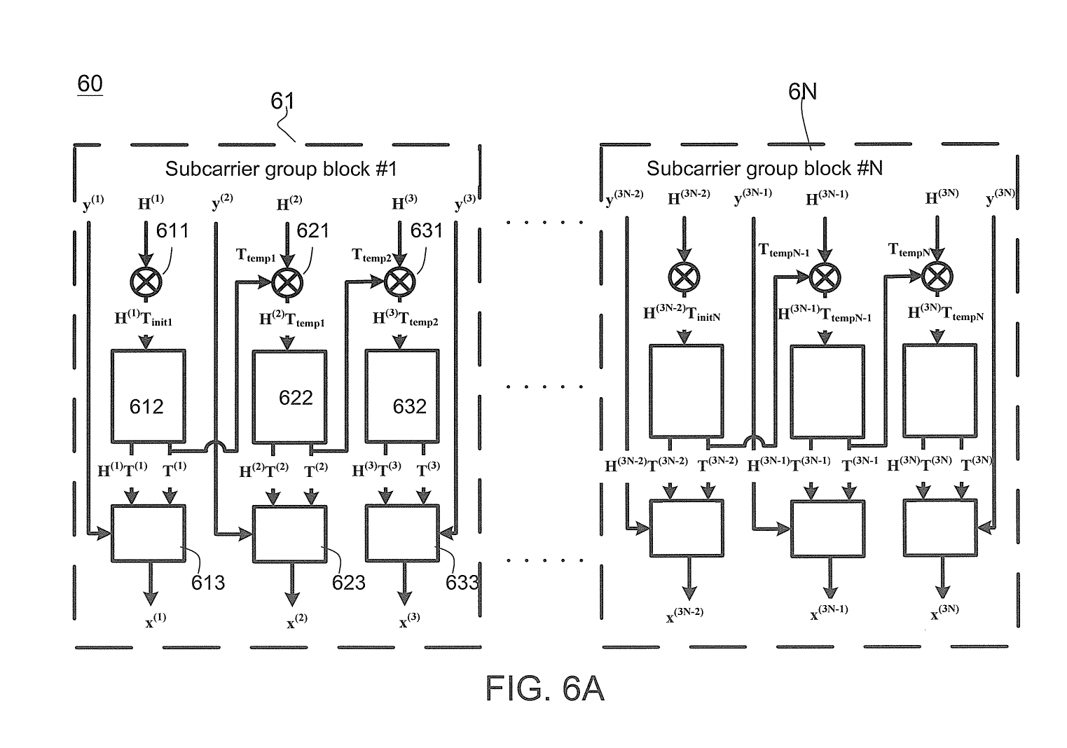

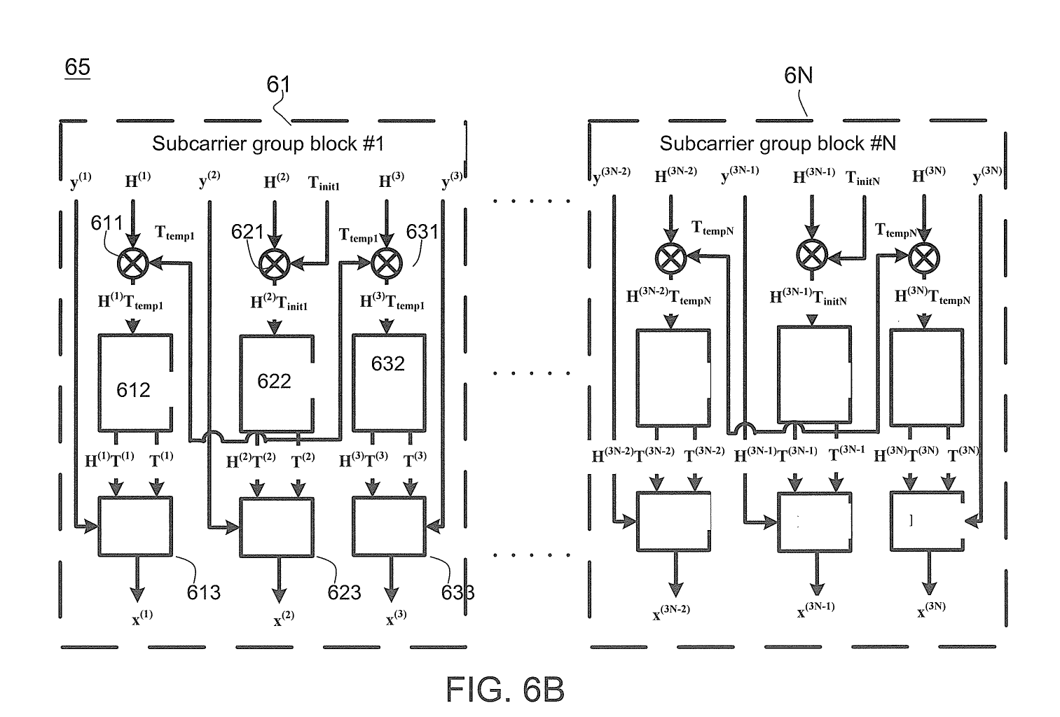

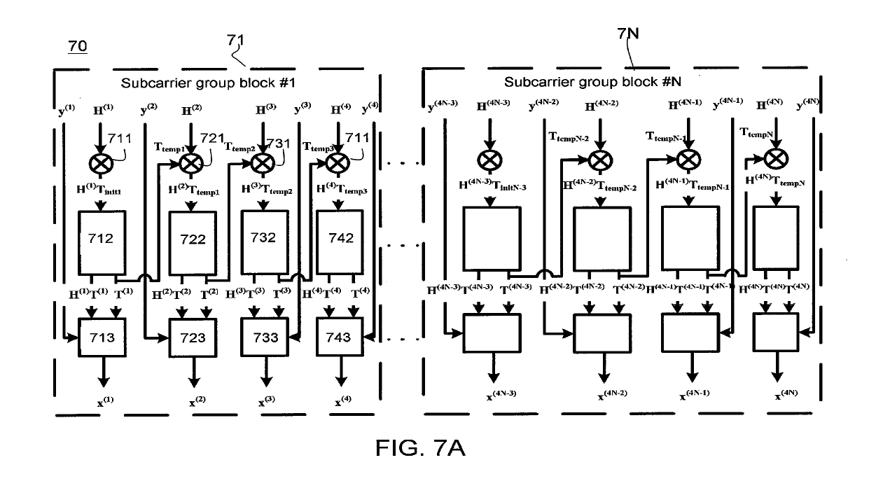

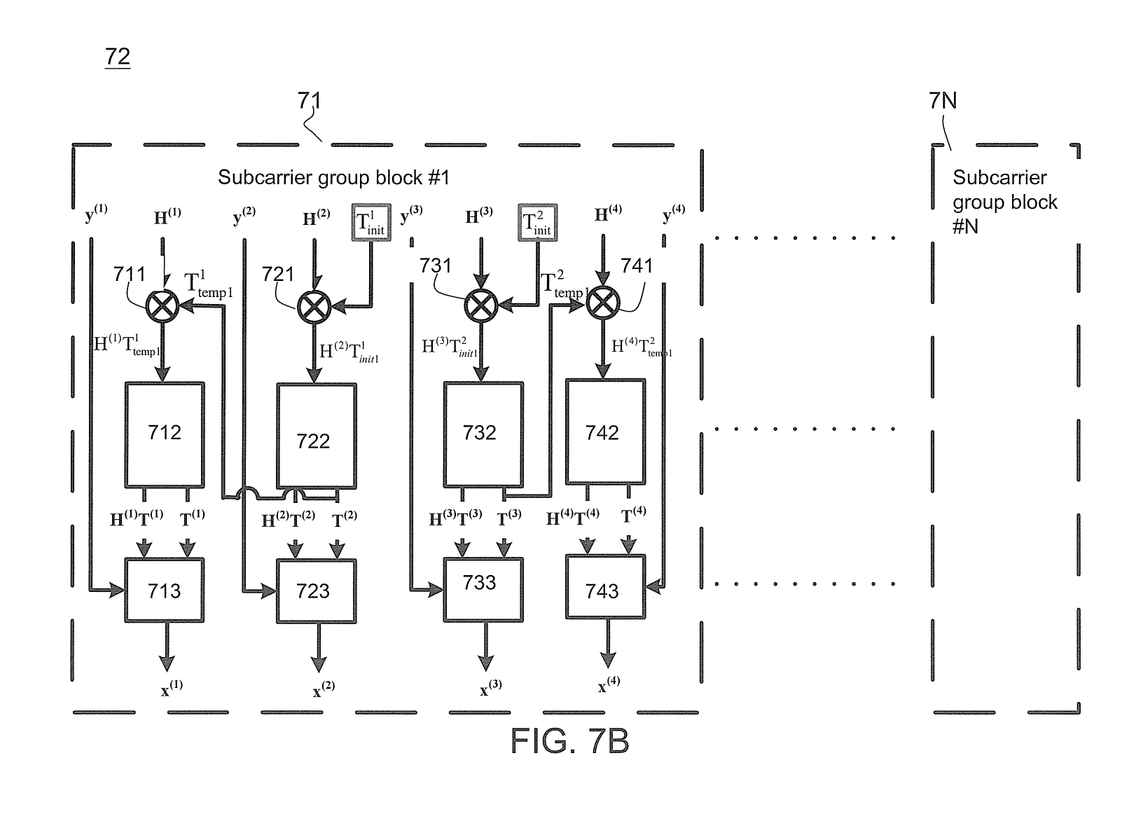

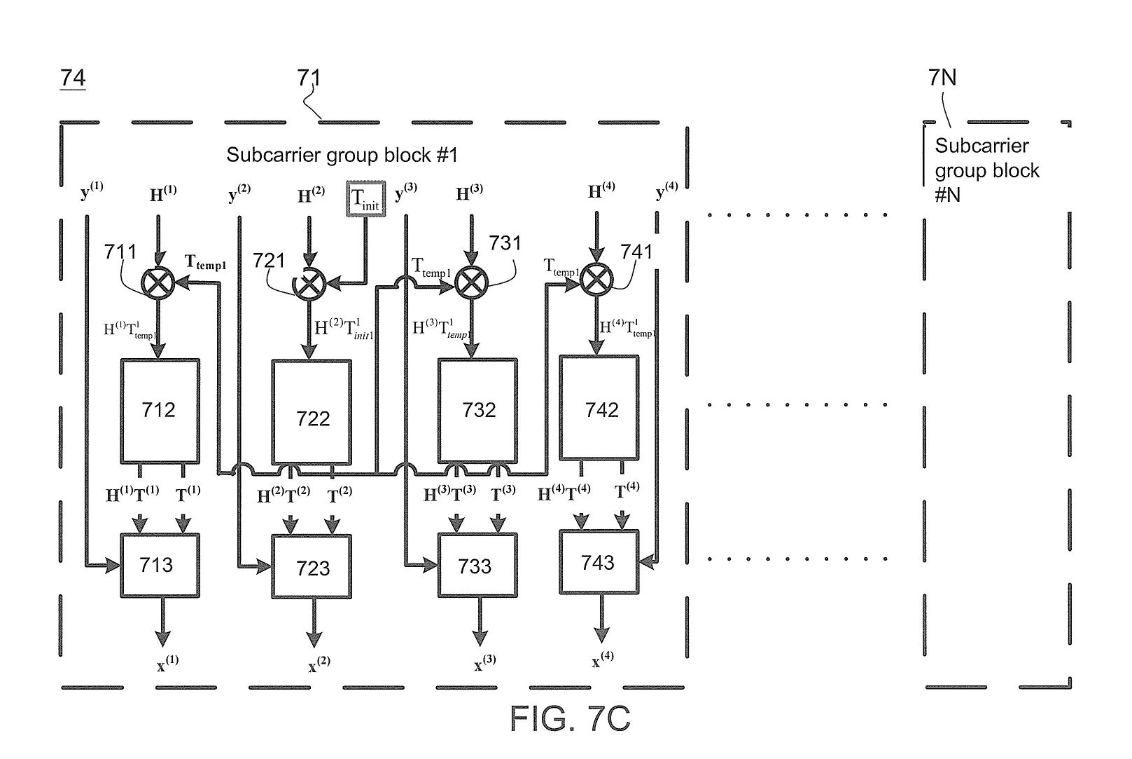

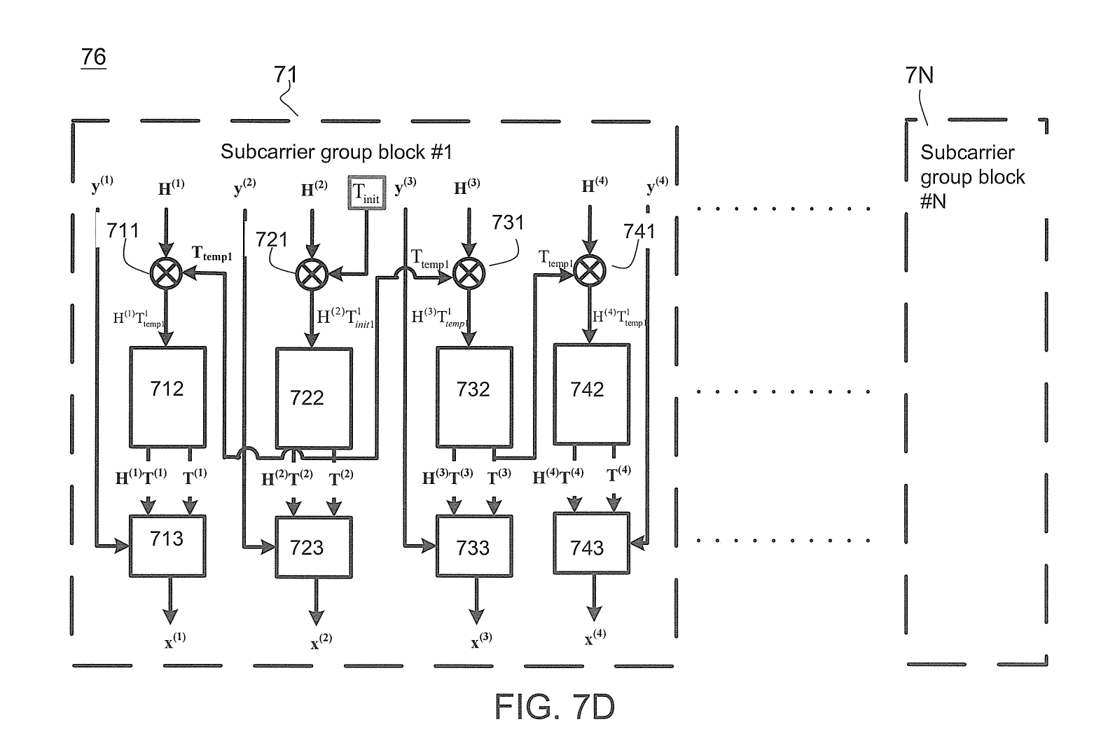

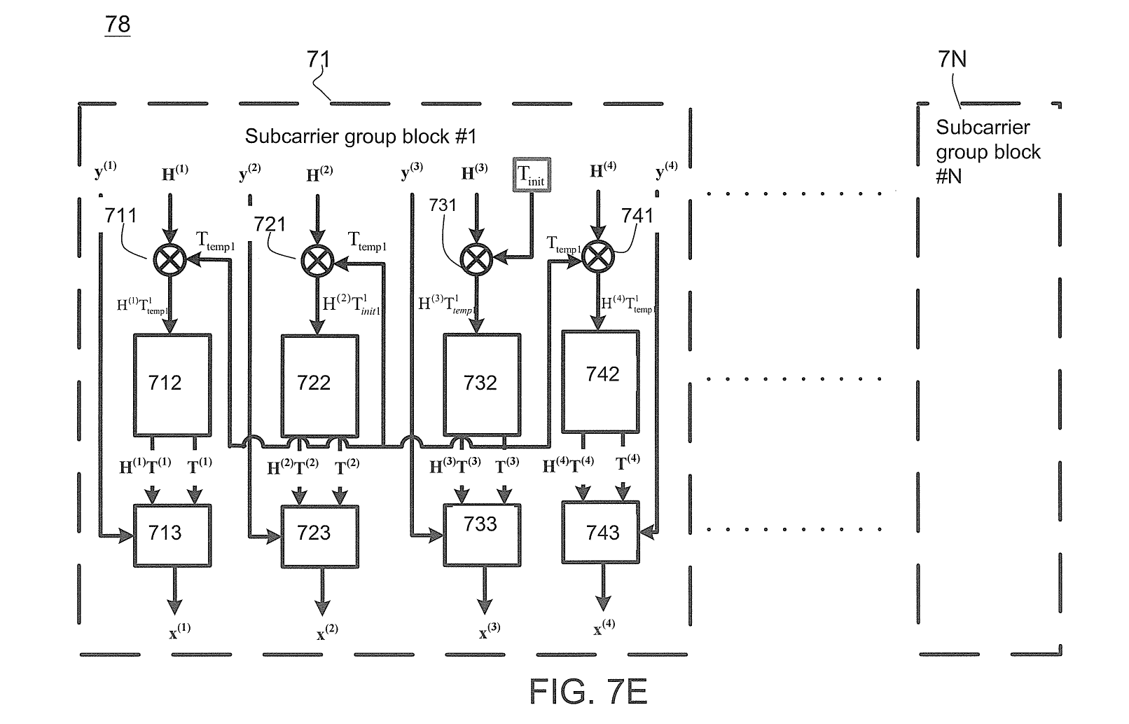

Referring to FIG. 5, when k is an odd number, the one or more of the processing modules receiving the initial matrix Tᵢₙᵢₜ can be the one located in the middle column of the processing group block as shown in FIG. 6B. When k is an even number, the one or more of the processing modules receiving the initial matrix Tᵢₙᵢₜ can include the two processing modules located in the middle columns of the processing group block as shown in FIG. 7B. Alternatively, when k is an even number, the at least one of the processing modules receiving the initial matrix Tᵢₙᵢₜ can be one of the two processing modules located in the middle columns of the processing group block as shown in FIGS. 7C-7E.

The lattice reduction architecture 50 also includes a memory module (not shown in FIG. 5). The memory unit can be configured for storing the last reduction matrix Tₜₑₘₚ_{_{—}}ₗₐₛₜ provided from at least one of the last processing modules being processed in the processing group block, and the last reduction matrix can be provided as an initial matrix Tᵢₙᵢₜ for performing the lattice reduction processing on channel matrices corresponding to received sub-carriers of the next cycle. The next cycle can be, for example, the next sub-frame duration.

FIG. 6A is schematic diagram illustrating a lattice reduction architecture 60 according to a fourth exemplary embodiment. In particular, the lattice reduction architecture 60 provides an example, where the number of group size k in each one of the sub-carrier group blocks #1, . . . , #N is 3. The lattice reduction architecture 60 is similar to the lattice reduction architecture 35, and includes blocks 61, . . . , 6N. Also, the block 61 (i.e., the sub-carrier group block #1) illustrates one of the different operation approaches which can be applied to any sub-carrier group blocks in the lattice reduction architecture 35.

Referring to FIG. 6A, the number of the processing modules in the sub-carrier group block #1 is 3. Since all blocks 61, . . . , 6N may be the same, only the block 61 is described in more details. The processing module on one side (or on one the side column) of the sub-carrier group block #1, such as the first processing module, includes a multiplier 611, a LR processing unit 612, and a decision unit 613. The multiplier 611 receives inputs of received OFDM sub-carriers H⁽¹⁾ with an initial matrix Tᵢₙᵢₜ, and outputs multiplication result H⁽¹⁾Tᵢₙᵢₜ. The multiplication result H⁽¹⁾Tᵢₙᵢₜ is further input to the LR processing unit 612. The LR processing unit 612 can provide reduction matrix Tₜₑₘₚ₁ before the LR processing is complete. However, the present disclosure is not limited thereto. In other embodiment, the LR processing unit 612 can also provide reduction matrix Tₜₑₘₚ₁ when the LR processing is complete. The reduction matrix Tₜₑₘₚ₁ is provided to a multiplier 621 of a neighboring processing module, and the LR processing unit 612 output the multiplication result H⁽¹⁾T⁽¹⁾ and the reduction matrix T⁽¹⁾ to the decision unit 613 when the LR processing is complete. The decision unit 613 receives the inputs of the received OFDM sub-carrier y⁽¹⁾, the multiplication result H⁽¹⁾T⁽¹⁾ and the reduction matrix T⁽¹⁾, and the demodulated sub-carriers x⁽¹⁾ is generated accordingly.

The multiplier 621, the LR processing unit 622, and the decision unit 623 operate in a similar manner as described previously for the first processing module. In particular, the LR processing unit 622 receives the multiplication result H⁽²⁾Tₜₑₘₚ₁ from the multiplier 621, and output reduction matrix Tₜₑₘₚ₂ to a multiplier 631 of the last processing module. Meanwhile, the LR processing unit 622 continue to complete the LR processing, so as to output the multiplication result H⁽²⁾T⁽²⁾ and reduction matrix T⁽²⁾. The decision unit 623 receives the input of the received OFDM sub-carrier y⁽²⁾ along with the multiplication result H⁽²⁾T⁽²⁾ and the reduction matrix Y⁽²⁾ and output the demodulated sub-carriers x⁽²⁾ accordingly. The multiplier 631, the LR processing unit 632, and a decision unit 633 operate in a similar manner as described previously for the first processing module, so the detailed operation is not described herein.

FIG. 6B is schematic diagram illustrating a lattice reduction architecture according to a fifth exemplary embodiment. In particular, the lattice reduction architecture 60 provides an example, where the number of group size k in each one of the sub-carrier group blocks #1, #N is 3. The lattice reduction architecture 65 is similar to the lattice reduction architecture 60 except that the initial matrix Tᵢₙᵢₜ is firstly provided to the processing module in the middle (such as the one including the multiplier 621, the LR processing unit 622, and the decision unit 623). Also, the LR processing unit 622 provides the reduction matrix Tₜₑₘₚ simultaneously to adjacent processing modules on both sides (the processing modules on adjacent side columns) such that the processing latency can be further reduced. Since the first processing module, the second processing module and the third processing module operate similarly in terms of LR processing, the detailed operations of the LR processing for each one of the processing modules are not repeated herein.

FIG. 7A is schematic diagram illustrating a lattice reduction architecture according to a sixth exemplary embodiment. In particular, the lattice reduction architecture 70 provides an example, where the number of group size k in each one of the sub-carrier group blocks #1, . . . , #N is 4. The lattice reduction architecture 70 is similar to the lattice reduction architecture 60, where the initial matrix is firstly supplied to the processing module on the side column (such as the first processing module including the multiplier 711, the LR processing unit 712, and the decision unit 713). Also, the LR processing unit 712 provide reduction matrix Tₜₑₘₚ₁ to a multiplier 721 of an adjacent processing module (such as the second processing module including the multiplier 721, the LR processing unit 722, and the decision unit 723) when the LR processing is complete. In other embodiment, the LR processing unit 712 can also provide reduction matrix Tₜₑₘₚ₁ to the adjacent processing module within predetermined loops. The predetermined loops are, for example, 10 loops or 20 loops.

The same processing approach repeats such that the LR processing unit 722 provides reduction matrix Tₜₑₘₚ₂ to adjacent processing module (such as the third processing module including the multiplier 731, the LR processing unit 732, and the decision unit 733) when the LR processing is complete or within predetermined loops.

Furthermore, the LR processing unit 732 provides reduction matrix Tₜₑₘₚ₃ to adjacent processing module (such as the fourth processing module including the multiplier 741, the LR processing unit 742, and the decision unit 743) when the LR processing is complete or within predetermined loops. Accordingly, each one of the processing modules successively provide reduction matrices Tₜₑₘₚ₁, Tₜₑₘₚ₂, Tₜₑₘₚ₃ to one adjacent processing modules until all processing modules have been operating and generate demodulated sub-carriers x⁽¹⁾, x⁽²⁾, x⁽³⁾, x⁽⁴⁾.

FIG. 7B is schematic diagram illustrating a lattice reduction architecture 72 according to a seventh exemplary embodiment. In particular, the lattice reduction architecture 72 provides an example, where the number of group size k in each one of the sub-carrier group blocks #1, . . . , #N is 4. The lattice reduction architecture 72 is similar to the lattice reduction architecture 65. However, since there are 4 of processing modules in a sub-carrier group block, there can be two processing modules in the middle columns (or in the middle of the sub-carrier group block #1) simultaneously operating initially.

Referring to FIG. 7B, the initial matrices T¹ᵢₙᵢₜ, T²ᵢₙᵢₜ are firstly supplied to the processing modules on the middle column (such as the second and the third processing modules respectively including the multiplier 721, the LR processing unit 722, and the decision unit 723, the multiplier 731, the LR processing unit 732, and the decision unit 733). Also, the LR processing units 722, 732 respectively provide reduction matrices T¹ₜₑₘₚ₁, T²ₜₑₘₚ₁ to a multipliers 711, 741 of adjacent processing modules (such as the first and the fourth processing modules respectively including the multiplier 711, the LR processing unit 712, and the decision unit 713, the multiplier 741, the LR processing unit 742, and the decision unit 743) when the LR processing is complete. In other embodiment, the LR processing units 722, 732 can also respectively provide reduction matrix T¹ₜₑₘₚ₁, T²ₜₑₘₚ₁ to the adjacent processing modules within predetermined loops.

Accordingly, each one of the processing modules successively obtains initial matrix Tᵢₙᵢₜ from previous processing stage or reduction matrix Tₜₑₘₚ from a adjacent processing module until all processing modules have been operating and generate demodulated sub-carriers x⁽¹⁾, x⁽²⁾, x⁽³⁾, x⁽⁴⁾. Since all processing modules of the sub-carrier group block #1 operates in a similar manner in terms of LR processing, the detailed of each one of the processing modules in the lattice reduction architecture 72 is not described in details herein.

FIG. 7C is schematic diagram illustrating a lattice reduction architecture according 74 to an eighth exemplary embodiment. In particular, the lattice reduction architecture 74 provides an example, where the number of group size k in each one of the sub-carrier group blocks #1, . . . , #N is 4. The lattice reduction architecture 74 is similar to the lattice reduction architecture 65. However, since there are 4 of processing modules in a sub-carrier group block, one processing module (such as the one including the multiplier 721, the LR processing unit 722 and the decision unit 723) in the middle columns (or in the middle of the sub-carrier group block #1) obtains an initial matrix Tᵢₙᵢₜ and thus operates initially.

Referring to FIG. 7C, the LR processing unit 722 provides the reduction matrix Tₜₑₘₚ₁ to all of adjacent processing modules when the LR processing is complete. However, the present disclosure is not limited thereto, and in other embodiments, the LR processing unit 722 can also provide the reduction matrix Tₜₑₘₚ₁ to all of adjacent processing modules within predetermined loops. Accordingly, each one of the processing modules successively obtains initial matrix Tᵢₙᵢₜ from previous processing stage or reduction matrix Tₜₑₘₚ₁ from a processing module in the same sub-carrier group block until all processing modules have been operating and generate demodulated sub-carriers x⁽¹⁾, x⁽²⁾, x⁽³⁾, x⁽⁴⁾. Since all processing modules of the sub-carrier group block #1 operates in a similar manner in terms of LR processing, the detailed of each one of the processing modules in the lattice reduction architecture 72 is not described in details herein.

FIG. 7D is schematic diagram illustrating a lattice reduction architecture 76 according to a ninth exemplary embodiment. In particular, the lattice reduction architecture 76 provides an example, where the number of group size k in each one of the sub-carrier group blocks #1, . . . , #N is 4. The lattice reduction architecture 76 is similar to the lattice reduction architecture 74 except that the LR processing unit 722 of the second processing module does not provide reduction matrix Tₜₑₘₚ₁ to all processing modules within the same sub-carrier group block #1. The multiplier 741 of the fourth processing module obtains the reduction matrix Tₜₑₘₚ₁ from the LR processing unit 732. Compared with the lattice reduction architecture 74, the lattice reduction architecture 76 may induce longer latency but have less complexity.

FIG. 7E is schematic diagram illustrating a lattice reduction architecture 78 according to a tenth exemplary embodiment. In particular, the lattice reduction architecture 78 provides an example, where the number of group size k in each one of the sub-carrier group blocks #1, . . . , #N is 4. The lattice reduction architecture 78 is similar to the lattice reduction architecture 74 except that the third processing module (such as the one including the multiplier 731, the LR processing unit 732 and the decision unit 733) in the middle columns (or in the middle of the sub-carrier group block #1) obtains an initial matrix Tᵢₙᵢₜ and thus operates initially. The rest operations are similar to those described for FIG. 7C, so the detailed operations of the lattice reduction architecture 78 are not described herein.

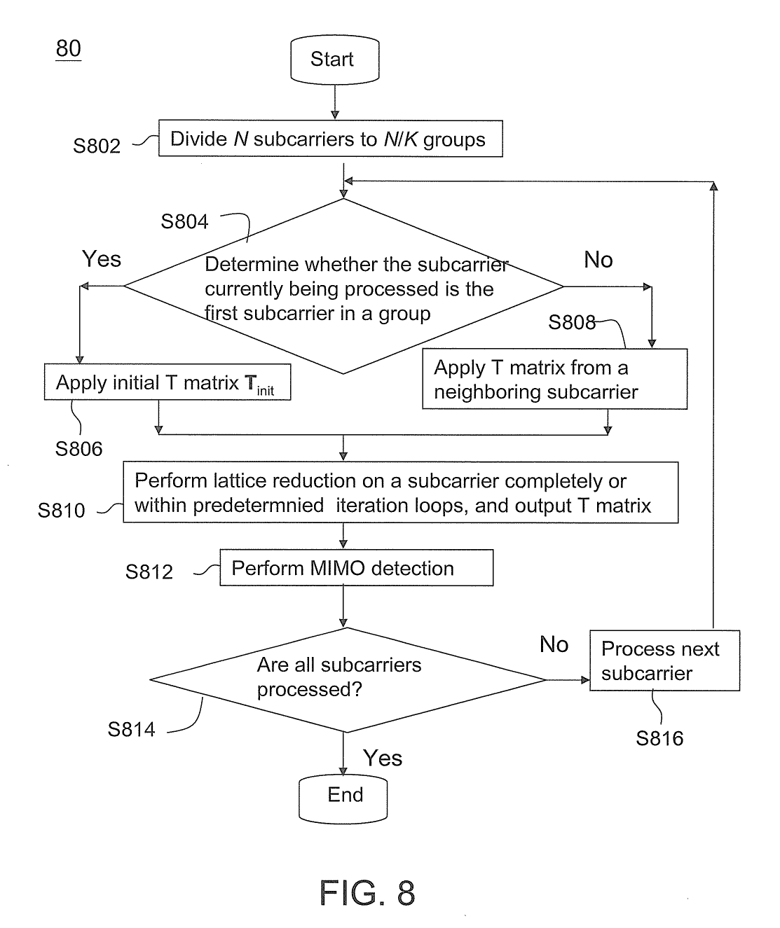

FIG. 8 is flowchart illustrating a lattice reduction method 80 according to an exemplary embodiment. The lattice reduction method 80 can be applied to all proposed embodiments illustrated in FIGS. 4A-4B, 5, 6A-6B and 7A-7E. However, the present disclosure is not limited just to the embodiments illustrated in FIGS. 4A-4B, 5, 6A-6B and 7A-7E. Any lattice reduction architecture, lattice reduction method, MIMO detector, OFDM-MIMO detector, or detection system implemented according the same spirit disclosed in the aforementioned embodiments should still be within the claimed scope of the present disclosure. The lattice reduction method 80 can be adapted for performing the lattice reduction on a plurality of received sub-carriers.

The lattice reduction method 80 starts from step S802. In the step S802, N received sub-carriers in the received symbol are firstly divided into N/k groups. It is assumed there are totally N sub-carriers in the received MIMO-OFDM symbols. In other words, every k of sub-carriers are grouped and processed in the same sub-carrier group block and there may be less than k of sub-carriers in the last sub-carrier group block. Also, the N sub-carriers have their respective channel matrices, and these channel matrices are also received at the step S802. For example, the lattice reduction method 80 is applied on a detection system, and the detection system has received the channel matrices respectively corresponding to the N sub-carriers from a previous processing stage, such as a channel state information estimation module external to the detection system.

In the step S802, when the number of sub-carriers, N, is not divisible by the group size, k, N sub-carriers in the received symbol are firstly divided into ┌N/k┐ groups, where ┌┐ is a ceiling function, and the last group (i.e., the sub-carrier group (#┐N/k┌) includes w sub-carriers, where w is a computation result of N modulo k.

In the step S804, it is determined that whether the sub-carrier currently being processed is the first sub-carrier or one of the first set of sub-carriers being processed in a sub-carrier group (or a sub-carrier group block). Here, the first sub-carrier does not refer to the sub-carrier being processed by the first processing module as shown in FIG. 5. The first sub-carrier or the first set of sub-carriers is referred to the sub-carrier or the sub-carriers being processed at the very first stage where an initial matrix is supplied to their respective processing modules.

Thus, when the sub-carrier currently being processed is determined to be the first sub-carrier or first set of sub-carriers being processed in the sub-carrier group in the step S804, step S806 is executed after the step S804. On the contrary, when the sub-carrier currently being processed is determined not being the first sub-carrier or first set of sub-carriers being processed in the sub-carrier group in the step S804, step S808 is executed after the step S804.

In the step S806, an initial matrix (or initial T matrix) Tᵢₙᵢₜ is applied to the sub-carrier or the sub-carriers currently being processed. In particular, the initial matrix Tᵢₙᵢₜ is supplied to the multiplier of the processing module(s) configured for processing the sub-carrier(s). In the step S808, a reduction matrix (or temporary T matrix) Tₜₑₘₚ from a neighboring sub-carrier is applied to the sub-carrier being processed or the sub-carriers currently being processed. In particular, the reduction matrix Tₜₑₘₚ is supplied to the multiplier of the processing module(s) configured for processing the sub-carrier(s). As described previously, the reduction matrix Tₜₑₘₚ is output from the LR processing unit of an adjacent or neighboring processing module.

In step S810, the lattice reduction algorithm is performed on a channel matrix corresponding to the sub-carrier completely or within some (or predetermined) iteration loops at one or more processing modules, and a reduction matrix (or a temporary T matrix) Tₜₑₘₚ is output or provided to one or more neighboring processing modules. In step S812, MIMO detection is performed on the sub-carrier according to the received sub-carrier y and the output from the LR processing unit. In step S814, it is to determine whether all sub-carriers in a group (or in a sub-carrier group block) are all processed. The determination is made within fixed time duration such as a sub-frame.

When all sub-carriers in a group (or in a sub-carrier group block) are all processed, the lattice reduction method 80 is terminated. On the contrary, when sub-carriers in a group (or in a sub-carrier group block) are not all processed, step S816 is executed after the step S814. In the step S816, a next sub-carrier or a next set of sub-carriers are processed. It is noted that, since the reduction matrix Tₜₑₘₚ can be output within predetermined iteration loops in the step S810, the next sub-carrier or the next set of sub-carriers may be processed while the LR processing unit providing the reduction matrix Tₜₑₘₚ is still processing its own sub-carrier.

The step S804 to the step S816 can be repeated until all processing modules are operated, and their respective demodulated sub-carriers are output from their decision units. Also, when there is no initial matrix Tᵢₙᵢₜ available, an identity matrix can be delivered into any sub-carrier of one group (or a sub-carrier group block) as the initial T matrix (the initial matrix Tᵢₙᵢₜ). Moreover, a reduction matrix Tₜₑₘₚ generated at the final processing module(s) of a previous sub-frame can be used as the initial matrix Tᵢₙᵢₜ for the successive sub-frame.

In other words, the lattice reduction method 80 can be modified to have an additional step, which stores the last reduction matrix Tₜₑₘₚ_{_{—}}ₗₐₛₜ provided from at least one of the last processing modules being processed in the group, and then provides the last reduction matrix as an initial matrix for processing received sub-carriers of the next cycle. Here, the next cycle can be, for example, the next sub-frame period.

In the present disclosure, the proposed lattice reduction architecture (see FIG. 4A) for the MIMO-OFDM system, sub-carriers are divided into G groups and each group contains k sub-carriers. An identity matrix is delivered into any sub-carrier of one group as the initial T matrix. The output T matrix from the sub-carrier is then input to the other sub-carriers in the same group as a preprocessing LR matrix. This preprocessing approach can solve a long latency problem of the sequential architecture. Besides, the intermediate T matrix of the sub-carrier may also be delivered to other sub-carriers before the lattice reduction is complete. When wireless channel varies tremendously among neighboring sub-carriers, using adjacent sub-carrier's final LR matrix may not reduce total complexity. Therefore, reducing the loop number of LR processing method (such as a LLL algorithm), that is, outputting T matrix earlier, not only lower the latency but also maintains the same computation complexity cost.

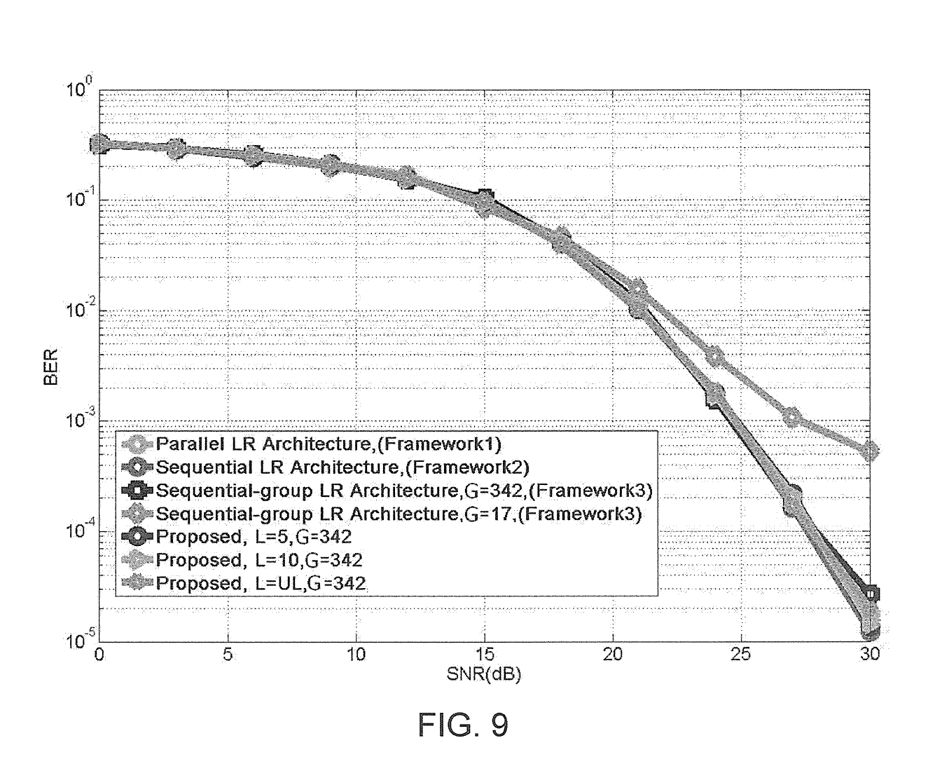

FIG. 9 is a diagram illustrating signal-to-noise-ratio (SNR) performance versus bit-error-rate (BER) performance for different LR architectures, where L is the predetermined loop number, and G=N/k is the total group number. In FIG. 9, Framework 1 can be referred to FIG. 3A and illustrates a parallel LR-aided MIMO OFDM detection processing. Framework 2 can be referred to FIG. 3B and illustrates a sequential LR-aided MIMO OFDM detection processing. Framework 3 is that N sub-carriers are divided into N/k groups, and the matrix T with this group is used as the initial T matrix for next group. Framework 3 can be referred to FIG. 3C. Also, in every group of Framework 3, just only one lattice reduction processing is performed. In the present disclosure, the computation complexity and latency of parallel LR architecture, sequential LR architecture and the proposed LR architecture are compared. The experiment is conducted to simulate a 4×4 MIMO-OFDM system with 16-quadrature amplitude modulation (QAM) and 1,024 of sub-carriers under the Extended Typical Urban (ETU), Extended Vehicle-A (EVA), and Extended Pedestrian-A (EPA) channel models of the 3GPP-LTE system. FIG. 9 shows the BER performances of all LR processing architectures under EPA channel. The SNR is measured in decibel (dB). These LR processing architectures cause no performance loss under three channel models.

At the receiver end, the channel matrix of each sub-carrier is assumed perfectly known. All operations in the algorithm such as addition, multiplication, division, and square root operation are counted for fair comparison. Real-valued operation is counted, that is, one complex-valued addition equals two real-valued additions. The reduction matrix T matrix multiplication at the input is also taken into consideration in calculation of computational complexity and latency in sequential LR architecture and the proposed LR processing method. The complex-valued QR decomposition is used in the preprocessing of all the lattice reduction. The parameter L in our method defines the number of calculated LLL loops before outputting the reduction matrix T (or the T matrix). UL defines that LLL lattice reduction is always completely done in the middle sub-carrier before outputting T matrix to the adjacent sub-carriers. In FIG. 5, the dashed lines represent the critical paths of the lattice reduction architecture for MIMO-OFDM.

In the present disclosure, proposed LR processing architecture and method thereof are actually a latency-constrained low-complexity LR scheme, which may be used for the MIMO-OFDM system or any other MIMO systems. The proposed LR processing architecture and method thereof can also be implemented as a detection system which receives sub-carriers and detects the transmitted sub-carriers after performing the proposed LR processing method on the received sub-carriers in the proposed LR processing architecture.

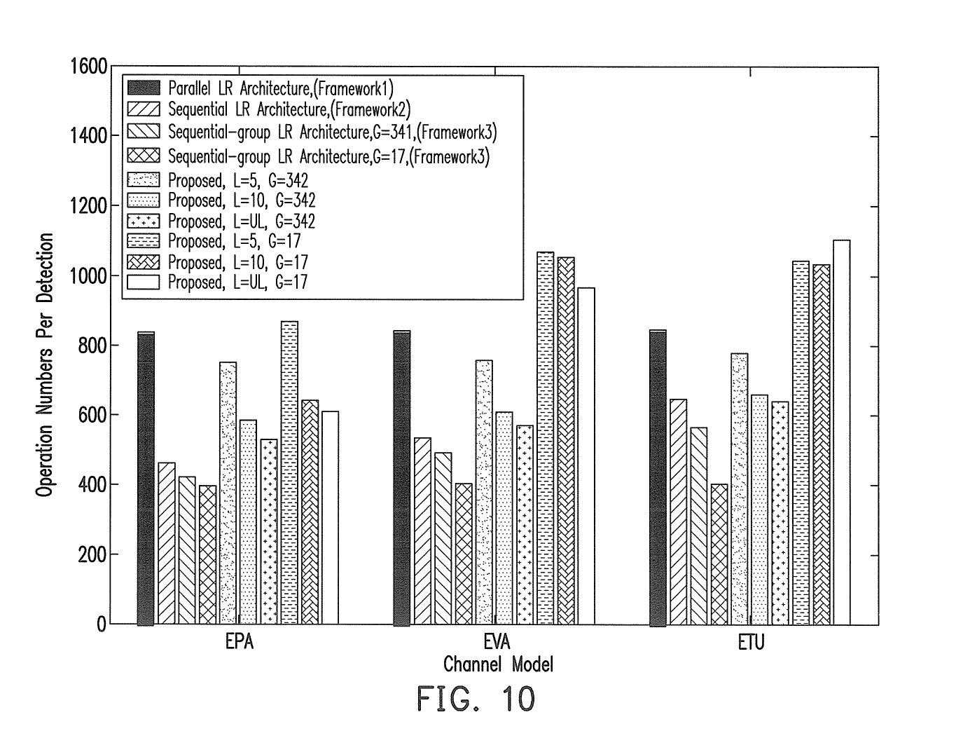

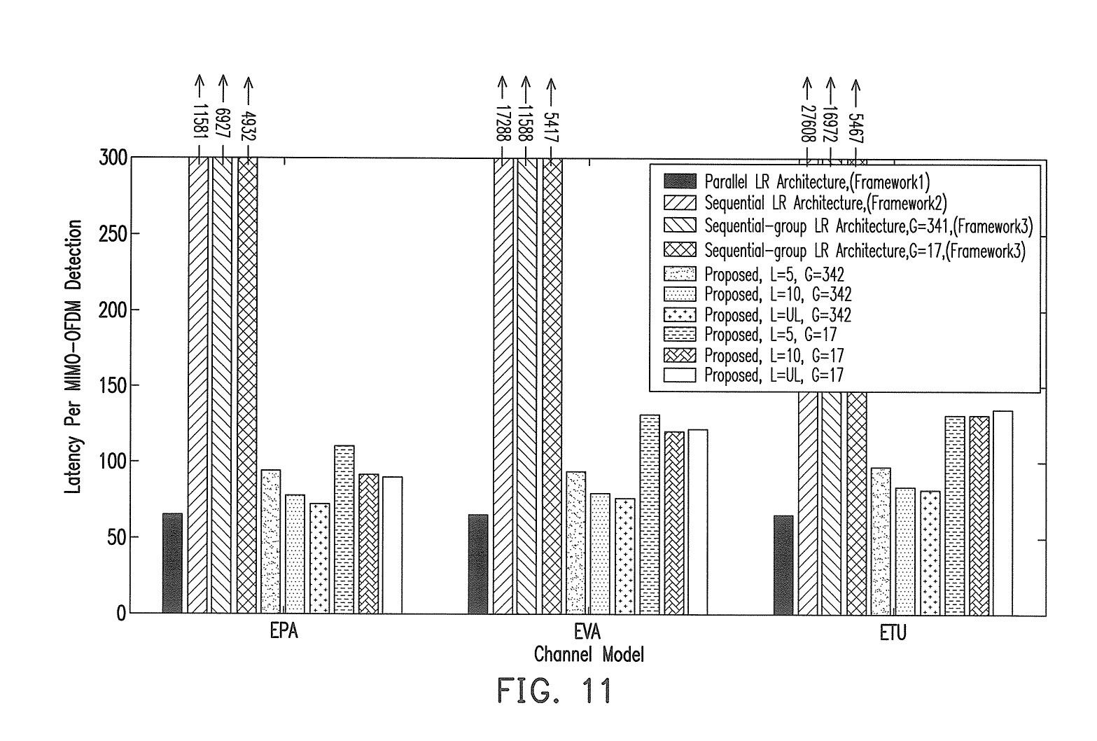

The proposed LR scheme, or the LR processing architecture and method thereof can reduce the critical computational time in the LR-aided MIMO-OFDM processing. The performance of LR processing architecture and calculation of the processing latency of the proposed technique using different MIMO channels for the 3GPP-LTE system is provided along with simulation results. The simulation of the proposed LR-aided MIMO-OFDM processing is conducted in the 3GPP-LTE system. The simulation result will be presented in FIGS. 10-11. The proposed LR architecture and the method thereof not only reduce the computational complexity but also shorten the latency for the lattice reduction.

FIG. 10 and FIG. 11 show the computational complexity and latency of different architectures. It is observed in FIG. 10 and FIG. 11 that the sequential LR architecture has a lower computational complexity than the straightforward parallel LR architecture because the sequential LR architecture takes advantage of the coherent property of adjacent sub-carriers. Therefore, the LLL lattice reduction algorithm requires smaller number of loops for each sub-carrier.

However, the sequential operation of the lattice reduction algorithm leads to very long latency in the MIMO-OFDM system. The latency calculation equations are listed in Table I for the three architectures. LR_latency_before_T represents the computational latency before the T matrix is delivered to the adjacent sub-carriers and LR_latency_after_T represents the computational latency of lattice reduction in the adjacent sub-carriers.

TABLE I
Lattice calculation method for different processing architecture

| Algorithm | Formula |
|---|---|
| Parallel LR Architecture | Total_LR_latency/N/symbol_number |
| [Framework 1] | |
| Sequential LR | Total_LR_latency/symbol_number |
| Architecture | |
| [Framework 2] | |
| Sequential-Group LR | Total_LR_latency/symbol_number |
| Architecture | |
| [Framework 3] | |
| Proposed Architecture | LR_latency_before_T/G/symbol_number + |
| | LR_latency_after_T/N/symbol_number |

Although the proposed LR processing architecture has higher complexity than the sequential LR architecture due to the incomplete operations of LLL algorithm, the proposed LR processing architecture can still reduce the complexity of the parallel LR architecture. Moreover, the proposed LR processing architecture has a much shorter latency than the sequential LR architecture because the proposed architecture uses coherent channel property only within one group. For the proposed LR processing architecture, increasing group size k (decreasing G) leads to the increase of complexity and latency. The primary reason is that group size becomes larger than the coherent bandwidth and thus LLL lattice reduction needs a larger number of loops to finish the LLL algorithm. Moreover, all architectures require larger complexity and longer latency for EVA and ETU channels because EVA and ETU channels have lower correlation in the MIMO matrix than the EPA channel.

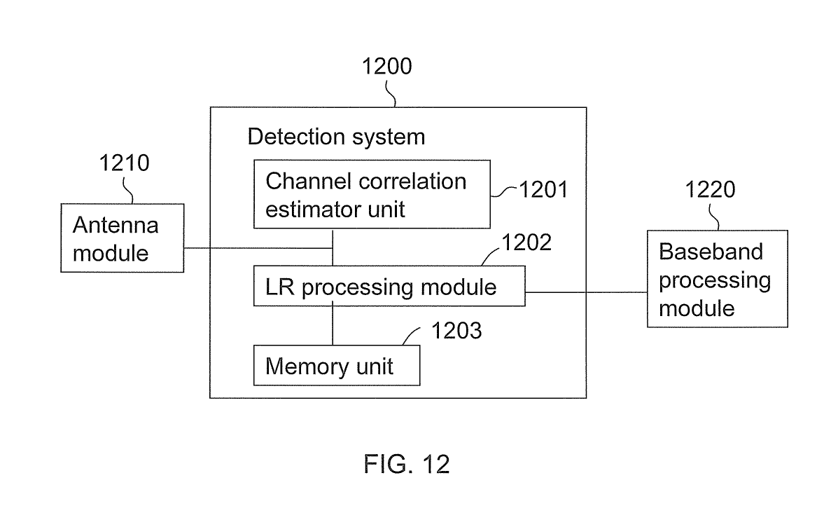

FIG. 12 is a functional block diagram illustrating a detection system 1200 according an exemplary embodiment. Referring to FIG. 12, the detection system 1200 is connected to an antenna module 1210 and a baseband processing module 1220. The detection system 1200 is adapted for detecting received signals on the antenna module 1210. The received signals can be, for example, received OFDM symbols including OFDM sub-carriers but is not limited thereto. The detection system 1200 includes a channel correlation estimator unit 1201, an LR processing module 1202, and a memory unit 1203.

The LR processing module 1202 is connected to the channel correlation estimator unit 1201, the antenna module 1210, and the baseband processing module 1220. The LR processing module 1202 has a lattice reduction architecture (similar to that shown in FIG. 5), which includes G processing group blocks and a channel correlation estimator unit. The G processing group blocks are configured for receiving channel matrices respectively corresponding to each one of the received signals, where each one of the first processing group block to the G-1th processing group block includes k processing modules configured for respectively processing k of received signals, and the Gth processing group block includes j processing modules, where G, j, and k are positive integers, and j<=k.

Moreover, in each one of the G processing group blocks, at least one of the processing modules receives an initial matrix Tᵢₙᵢₜ, where each one of the at least one processing module includes a lattice reduction processing unit configured for providing a reduction matrix Tₜₑₘₚ to at least one neighboring processing module in the same processing group block when a lattice reduction algorithm is processed on its respective received signals for at least predetermined iteration loops according to the channel matrix corresponding to the received signals and the received initial matrix Tᵢₙᵢₜ. The lattice reduction algorithm can be, for example, the Lenstra-Lenstra-Lovasz (LLL) algorithm.

Furthermore, LR processing module 1202 performs the lattice reduction on the received signals, generate demodulated signals and further provide the demodulated signals to the baseband processing module 1220.

The channel correlation estimator unit 1201 is connected to the LR processing module 1202 and the antenna module 1210. In fact, channel correlation estimator unit 1201 is connected to all processing modules in each one of the G processing group blocks. Also, the channel correlation estimator unit 1201 is configured for estimating correlations between a plurality of channels in the antenna module 1210 and adjusting the predetermined iteration loops according to the estimated correlations of the channels. In the present embodiment, the correlations of the channels refer to channel correlations between different sub-carriers or different received signals. In other words, the correlations of the channels can be referred to correlations between channel matrices corresponding to the sub-carriers or the received signals.

Moreover, the channel correlation estimator unit 1201 provides each one of the G processing group blocks with the channel matrix corresponding to its respective received signals or its respective sub-carriers. The channel correlation estimator unit 1201 increases the number of the predetermined iteration loops when the estimated correlations between the channels are high (e.g., the correlations between the channels are greater than or equal to 80%). The channel correlation estimator unit 1201 decreases the number of the predetermined iteration loops when the estimated correlations between the channels are low (e.g., the correlations between the channels are less than or equal to 1%).

The memory unit 1203 is connected to the LR processing module 1202, and stores the last reduction matrix Tₜₑₘₚ_{_{—}}ₗₐₛₜ provided from at least one of the last processing modules being processed in the processing group block. Moreover, the last reduction matrix is provided as an initial matrix for performing the lattice reduction on received signals of the next cycle. In addition, in the lattice reduction architecture of the detection system 1200, each one of the G processing group blocks can have one of the architecture as shown in the proposed embodiments illustrated in FIGS. 4A-4B, 5, 6A-6B and 7A-7E.

In summary, according to the exemplary embodiments of the disclosure, a lattice reduction architecture and a lattice reduction method and a detection system thereof are proposed. There proposed lattice reduction architecture can be applied on lattice reduction-aided MIMO-OFDM system. The proposed lattice reduction architecture not only reduces the computational complexity of the straightforward parallel lattice reduction architecture but also resolves the long latency problem in the sequential lattice reduction architecture. As such, the lattice reduction architecture can be suitable for hardware implementation for high-throughput MIMO-OFDM system.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A lattice reduction architecture, adapted for performing lattice reduction on channel matrices corresponding to a plurality of sub-carriers, comprising:
G processing group blocks, configured for receiving channel matrices respectively corresponding to each one of the sub-carriers, wherein each one of the first processing group blocks to the G-1 th processing group block includes k processing modules configured for respectively processing k of sub-carriers, and the Gth processing group block includes j processing modules, wherein G, j, and k are positive integers, and j<=k; and
wherein, in each one of the G processing group blocks, at least one of the processing modules receives an initial matrix Tᵢₙᵢₜ, wherein each one of the at least one processing module includes a lattice reduction processing unit configured for providing a reduction matrix Tₜₑₘₚ to at least one neighboring processing module in the same processing group block when a lattice reduction algorithm is processed for at least predetermined iteration loops or the lattice reduction algorithm is processed completely on a channel matrix corresponding to its respective sub-carrier according to the channel matrix corresponding to the sub-carrier and the received initial matrix Tᵢₙᵢₜ.

2. The lattice reduction architecture according to claim 1, wherein the lattice reduction algorithm is a Lenstra-Lenstra-Lovasz (LLL) algorithm.

3. The lattice reduction architecture according to claim 1, wherein the at least one processing module receiving the reduction matrix Tₜₑₘₚ further provides another reduction matrix Tₜₑₘₚ₁ to at least one neighboring processing modules which have not received any reduction matrix or the initial matrix in the same processing group block when lattice reduction algorithm is processed on a channel matrix corresponding to its respective sub-carrier for the at least predetermined iteration loops according to the channel matrix corresponding to the respective sub-carrier and the received reduction matrix Tₜₑₘₚ.

4. The lattice reduction architecture according to claim 1, wherein the lattice reduction processing unit provides the reduction matrix Tₜₑₘₚ when the lattice reduction algorithm is processed completely on a channel matrix corresponding to its respective sub-carrier according to the channel matrix corresponding to the respective sub-carrier and the received initial matrix Tᵢₙᵢₜ.

5. The lattice reduction architecture according to claim 1, wherein the at least one processing module receiving the reduction matrix Tₜₑₘₚ further provides another reduction matrix Tₜₑₘₚ₁ to at least one neighboring processing modules which have not received any reduction matrix or the initial matrix in the same processing group block when its respective lattice reduction algorithm is processed completely on a channel matrix corresponding to its respective sub-carrier according to the channel matrix corresponding to the sub-carriers and the received reduction matrix Tₜₑₘₚ.

6. The lattice reduction architecture according to claim 1, wherein the lattice reduction processing unit provides the reduction matrix Tₜₑₘₚ when the lattice reduction algorithm is processed for the at least predetermined iteration loops on a channel matrix corresponding to its respective sub-carrier according to the channel matrix corresponding to the respective sub-carrier and the received initial matrix Tᵢₙᵢₜ,

7. The lattice reduction architecture according to claim 1, wherein, when k is an odd number, the at least one of the processing modules receiving the initial matrix Tᵢₙᵢₜ is located in the middle column of the processing group block.

8. The lattice reduction architecture according to claim 1, wherein, when k is an even number, the at least one of the processing modules receiving the initial matrix Tᵢₙᵢₜ comprises the two processing modules located in the middle columns of the processing group block.

9. The lattice reduction architecture according to claim 8, wherein, when k is an even number, the at least one of the processing modules receiving the initial matrix Tᵢₙᵢₜ is one of the two processing modules located in the middle columns of the processing group block.

10. The lattice reduction architecture according to claim 1, the lattice reduction architecture further comprising:
a memory unit, configured for storing the last reduction matrix Tₜₑₘₚ_{_{—}}ₗₐₛₜ provided from at least one of the last processing modules being processed in the processing group block, wherein the last reduction matrix is provided as an initial matrix for performing the lattice reduction on received sub-carriers of the next cycle.

11. A lattice reduction method, adapted for performing lattice reduction on channel matrices corresponding to a plurality of received sub-carriers, comprising:
dividing N received subcarriers to ┌N/k┐ groups, wherein N and k are positive integers, and ┌┐ is a ceiling function;
receiving the channel matrices respectively corresponding to each one of the received sub-carriers.
for each one of the ┌N/k┐ groups, at least one of the processing modules in the each one of the ┌N/k┐ groups receiving an initial matrix Tᵢₙᵢₜ; and
processing a channel matrix corresponding to its respective sub-carrier at the at least one of the processing modules in the each one of the ┌N/k┐ groups by a lattice reduction algorithm according to the channel matrix corresponding to the respective sub-carrier and the received initial matrix Tᵢₙᵢₜ, and then providing a reduction matrix Tₜₑₘₚ to at least one neighboring processing module in the same group when the channel matrix corresponding to the respective sub-carrier is processed for at least predetermined iteration loops or the channel matrix corresponding to the respective sub-carrier is processed completely at the at least one of the processing modules by the lattice reduction algorithm.

12. The lattice reduction method according to claim 11, wherein the lattice reduction algorithm is a Lenstra-Lenstra-Lovasz (LLL) algorithm.

13. The lattice reduction method according to claim 11, wherein the method further comprising:
determining whether the received sub-carrier currently being processed is the at least one of the first sub-carriers being processed in a group;
when the sub-carrier currently being processed is determined to be the at least one of the first sub-carriers being processed in a group, applying the initial matrix Tᵢₙᵢₜ at the sub-carrier currently being processed; and
when the subcarrier currently being processed is determined not being the at least one of the first sub-carriers being processed in the group, applying the reduction matrix Tₜₑₘₚ at the sub-carrier currently being processed.

14. The lattice reduction method according to claim 13, the method further comprising:
performing detection on the sub-carrier currently being processed according to the initial matrix Tᵢₙᵢₜ the sub-carrier, and the channel matrix corresponding to the sub-carrier when the processing module receives the initial matrix Tᵢₙᵢₜ,

15. The lattice reduction method according to claim 13, the method further comprising:
performing detection on the sub-carrier currently being processed according to the reduction matrix Tₜₑₘₚ, the subcarrier, and the channel matrix corresponding to the sub-carrier when the processing module receives the reduction matrix Tₜₑₘₚ.

16. The lattice reduction method according to claim 13, the method further comprising:
when the lattice reduction algorithm is performed on the channel matrix corresponding to the sub-carrier for at least predetermined iteration loops according to the channel matrix and the received initial matrix Tᵢₙᵢₜ, providing a reduction matrix to at least one neighboring processing module in the same group.

17. The lattice reduction method according to claim 13, the method further comprising:
when the lattice reduction algorithm is performed completely on the channel matrix corresponding to the sub-carrier according to the channel matrix and the received initial matrix Tᵢₙᵢₜ providing a reduction matrix to at least one neighboring processing module in the same group.

18. The lattice reduction method according to claim 13, the method further comprising:
when the lattice reduction algorithm is performed for at least predetermined iteration loops on the channel matrix corresponding to the sub-carrier according to the channel matrix and the reduction matrix Tₜₑₘₚ providing a reduction matrix to at least one neighboring processing module in the same group.

19. The lattice reduction method according to claim 13, the method further comprising:
when the lattice reduction algorithm is completely performed on the channel matrix corresponding to the sub-carrier according to the channel matrix and the reduction matrix Tₜₑₘₚ, providing a reduction matrix to at least one neighboring processing module in the same group.

20. The lattice reduction method according to claim 11, the method further comprising:
storing the last reduction matrix Tₜₑₘₚ_{_{—}}ₗₐₛₜ provided from at least one of the last processing modules being processed in the group; and
providing the last reduction matrix as an initial matrix for performing the lattice reduction on received sub-carriers of the next cycle.

21. A detection system, adapted for detecting received signals, the detection system comprising:
G processing group blocks, configured for receiving channel matrices corresponding to the received signals, wherein each one of the first processing group block to the G-1th processing group block includes k processing modules configured for respectively processing k of received signals, and the Gth processing group block includes/processing modules, wherein G, j, and k are positive integers, j<=k, and, in each one of the G processing group blocks, at least one of the processing modules receives an initial matrix Tᵢₙᵢₜ, wherein each one of the at least one processing module includes a lattice reduction processing unit configured for providing a reduction matrix Tₜₑₘₚ to at least one neighboring processing module in the same processing group block when a lattice reduction algorithm is processed for at least predetermined iteration loops or the lattice reduction algorithm is processed completely on a channel matrix corresponding to its respective received signal according to the channel matrix corresponding to the sub-carrier and the received initial matrix Tᵢₙᵢₜ; and
a channel correlation estimator unit, connected to all processing modules in each one of the G processing group blocks, configured for estimating correlations between a plurality of channels, and adjusting the predetermined iteration loops according to the estimated correlations of the channels.

22. The detection system according to claim 21, wherein the channel correlation estimator unit increases the number of the predetermined iteration loops when the estimated correlations between the channels are high.

23. The detection system according to claim 21, wherein the channel correlation estimator unit decreases the number of the predetermined iteration loops when the estimated correlations between the channels are low.

24. The detection system according to claim 21, wherein the lattice reduction algorithm is a Lenstra-Lenstra-Lovasz (LLL) algorithm.

25. The detection system according to claim 21, wherein the at least one processing module receiving the reduction matrix Tₜₑₘₚ further provides another reduction matrix Tₜₑₘₚ₁ to at least one neighboring processing modules which have not received any reduction matrix or the initial matrix in the same processing group block when the lattice reduction algorithm is processed for the at least predetermined iteration loops according to the channel matrix corresponding to the received signal and the received reduction matrix Tₜₑₘₚ.

26. The detection system according to claim 21, wherein the at least one processing module receiving the reduction matrix Tₜₑₘₚ further provides another reduction matrix Tₜₑₘₚ₁ to at least one neighboring processing modules which have not received any reduction matrix or the initial matrix in the same processing group block when the lattice reduction algorithm is processed completely according to the channel matrix corresponding to the received signal and the received reduction matrix Tₜₑₘₚ.

27. The detection system according to claim 21, wherein the lattice reduction processing unit provides the reduction matrix Tₜₑₘₚ when the lattice reduction algorithm is processed for the at least predetermined iteration loops on a channel matrix corresponding to its respective sub-carrier according to the channel matrix corresponding to the respective sub-carrier and the received initial matrix Tᵢₙᵢₜ.

28. The detection system according to claim 21, wherein the lattice reduction processing unit provides the reduction matrix Tₜₑₘₚ when the lattice reduction algorithm is processed completely on a channel matrix corresponding to its respective sub-carrier according to the channel matrix corresponding to the respective sub-carrier and the received initial matrix Tᵢₙᵢₜ.

29. The detection system according to claim 21, wherein, when k is an odd number, the at least one of the processing modules receiving the initial matrix Tᵢₙᵢₜ is located in the middle column of the processing group block.

30. The detection system according to claim 21, wherein, when k is an even number, the at least one of the processing modules receiving the initial matrix Tᵢₙᵢₜ comprises the two processing modules located in the middle columns of the processing group block.

31. The detection system according to claim 30 wherein, when k is an even number, the at least one of the processing modules receiving the initial matrix Tᵢₙᵢₜ is one of the two processing modules located in the middle columns of the processing group block.

32. The detection system according to claim 21, the lattice reduction architecture further comprising:
a memory unit, configured for storing the last reduction matrix Tₜₑₘₚ_{_{—}}ₗₐₛₜ provided from at least one of the last processing modules being processed in the processing group block, wherein the last reduction matrix is provided as an initial matrix for performing the lattice reduction algorithm on channel matrices corresponding to received signals of the next cycle.
